(19) United States
(12) Patent Application Publication
(10) Pub. No.: US 2022/0403625 A1
(43) Pub. Date: Dec. 22, 2022

(54) SELF-PROPELLED INDUSTRIAL VEHICLE, DEVICE, OR ATTACHMENT WITH WORK OPTIMIZING CONTROLLER, METHOD OF OPERATION, AND CONTROLLER

(71) Applicant: Eagle Eye Consulting and Innovation s.r.o., Tresmonice (CZ)

(72) Inventor: Vaclav J. Jelinek, River Edge, NJ (US)

(21) Appl. No.: 17/696,835

(22) Filed: Mar. 16, 2022

Related U.S. Application Data
(60) Provisional application No. 63/161,968, filed on Mar. 16, 2021.

(51) Int. Cl. E02F 9/22; E02F 9/26

(52) U.S. Cl. CPC E02F 9/2203; E02F 9/265; E02F 9/2246

(57) ABSTRACT

A method, an apparatus, an attachment, a kit for an attachment, a vehicle and a controller for controlling the velocity of a processing machine or attachment so as to maximize the efficiency of a working tool in processing material. A vehicle or machine or industrial device frame having one or more power system providing power to an attachment processing machine. With one or more sensors sensing an input representing at least the power provided the attachment. An at least one controller adapted to calculate the work done at the attachment based on the power provided the attachment and maintaining the power to a stored or programmed efficient target value based in part on the adjustment of the feed rate of the work piece or work surface to the attachment or similar input or inputs.

### CROSS-REFERENCE TO RELATED APPLICATIONS

This application claims the priority U.S. provisional patent application 63/161,968 filed Mar. 16, 2021, which is incorporated herein by reference.

### BACKGROUND OF THE INVENTION

### Field of the Invention

The field of the instant invention includes controllers on a self-propelled industrial device, more specifically a controller on a working machine or vehicle or attachment, which can be for instance but is certainly not limited to the type found in the construction industry or agriculture, having motors and hydraulics that operate a cutting element, processing tool, attachment or the like which engages material in the environment or a work piece and which is moving relative to that environment on the working machine. An exemplary embodiment of the invention provides a controller that optimizes the feed rate of the processing interaction by measuring processing motor speed and/or power and adjusting the feed rate or forward velocity of the moving working machine to optimize the feed rate of material to the cutting element, processing tool, attachment, or the like, automatically and maximize work done by the attachment.

### Background of the Invention

In numerous industrial applications a tool or attachment is coupled to a moving working machine, industrial device, vehicle or static machine with moving feed tab, and the performance of the industrial device is dependent on maintaining an optimum feed rate of material to the tool by moving the device or vehicle relative to the material or work surface being fed to the tool or attachment. For instance, it is the case that a number of devices in the construction industry that cut, process or modify earthen or road surfaces are born by moving wheeled or tracked vehicles. The vehicle can be a dedicated machine or an attachment, which has or is coupled to a hydraulic system on the vehicle to drive and perform the cutting or other similar operation on the work surface. The efficiency of the use of this vehicle or attachment or tool is governed by a number of variables. Most significantly, these devices are highly dependent on their speed, e.g., feed rate, of the material to the processing element as governed by the velocity of the vehicle to maintain optimum performance, e.g., efficiency. Go too fast with the vehicle and the attachment motor, typically but not limited to a hydraulic motor system, will stall, slowing the work and affecting efficiency. Go too slow and the attachment motor needlessly spins, wasting fuel and decreasing performance.

Thus, it is the case that in these instances the existing work machines or vehicles that perform cutting or other processing functions require a highly skilled and experienced operator who is able to manually maintain an optimum advancement speed by feel, sound, and experience to make the machine function. Some prior examples provide operators with machines that have or provide visual indicators, such as gauges, to guide them toward the optimum performance, but this still requires constant monitoring of the indicator, interpretation, and manual input to adjust the advancement speed by the operator.

Even with such a skilled operator, the vehicle can still be subject to operator error or inefficiency, wasting time and fuel by needlessly spinning if the pressure in the system and the feed rate are not consistent or the operator does not push the envelope of such forces toward higher efficiency, for instance inadvertently conserving the machine speed when it could be advancing faster into the material. And with a non-skilled operator, the machine efficiency will suffer from a lack of capability to properly apply necessary pressure or worse yet may even be damaged by overloading of the machine.

Further complicating matters of control, the variability of density or strength in the material being processed or cut, even within a small area, is exceedingly high and can change across the work area. This makes the task of relative vehicle or device speed control to feed speed or rate all the more challenging. The surfaces, be they naturally occurring earth, vegetation, or asphalt for instance, have a wide variety in consistency, density, relative strength, and even depths. This further increases the likelihood of non-optimized operation even with a skilled operator at the controls.

This is a well-known issue that has seen extensive attempts to address, but none have significantly overcome the problem of optimizing the operation of the industrial device or vehicle and removing the reliance on and need for experienced operators. The existing devices on the market that attempt to address this issue on hydraulically operated tools, attachments and the like do not provide the necessary levels of automation and remain heavily reliant on the trained operators to interpret and adjust the device. The instant invention adds the heretofore unknown level of features to automate at the tool level these adjustments, making this a “smart attachment” enabled to idealize work output and reduce required operator experience. None of the existing devices provides for a “smart system” or “smart attachment” that optimizes attachment performance at the tool level.

Additionally, the existing prior art devices for aiding the operator in determining pressure have numerous disadvantages. Chief amongst those being that it is not practicably possible for the operator, who is often called to manage the processing apparatus by means of a principal machine with several outputs and inputs, to simultaneously monitor the attachment and to appreciate the instantaneous stress undergone by the processing apparatus or tool. In particular, it is difficult for the operator to precisely appreciate whether the instantaneous performance of the attachment or processing apparatus is close to the maximum performance pressures or not, and thus, whether it would be possible or not to have the machine undergo even greater workload by increasing the processing rate without stalling or otherwise overloading the power system of the machine.

Commercial pressure gauges that measure pressure are known in the state of the art and could be used by the operator. However, in this case, the operator would need to know a priori the setting and the calibration of the operating machine which they are going to operate and how that pressure relates to the work done. Furthermore, the pressure gauges of known types are often provided with a glass screen which might, in these particular operating conditions, cause problems related to safety. Moreover, the screen of these pressure gauges is usually of reduced dimensions and thus barely viewable by the operator at a distance. Some known attempts to improve the pressure gauge as a ruggedized package have been made.

One example of an attempt to provide an aid to the operator with an improved stress gauge packages for visualizing just this issue can be found in U.S. Pat. No. 9,297,715 B2 to Risi, commercially marketed by SIMEX as the “PERFORMER” which responds to machine hydraulic pressure, but requires an operator to continually monitor a visual pressure indicator, interpret that indicator, and change the speed or feed rate of the work machine correctly. Also, contrary to marketing material, the indicator does not indicate power, which is determined based on a combined function of pressure and flow within a hydraulic motor/system or an electrical motor/system. The Risi patent responds to pressure and provides it as outputs to a user via an indicator element for the user to make an adjustment. Although hydraulic pumps and systems of the powered vehicle try to attain consistent power as hydraulic flows or pressure change, limitations of hydraulic systems inevitably produce varying power at various pressure/flow combinations. Poorly designed hydraulic systems exacerbate these limitations making power variations more significant through the pressure/flow spectrum. Simple nonlogic-based measuring devices are not able to compensate for these variations making their use limited to only specific applications in a narrow, linear, flow/pressure regions which is usually short of the optimal non-linear flow/pressure region. The problems arise from the mechanical means used to turn pressure in the system to movement of the visual interpretation, e.g., manual inputs, and then the added issues of reaction and manual adjustment by the user or operator of these inputs. These problems are from a myriad of input issues via operations movement, e.g., unsteady hand operation and inputs with lag and visual acuity during operations of the sensors and the complex and distracting working environment all being compounding factors magnifying the issues with operator performance. There is no way fairly taught or suggested to relate the pressure measurement to an idealized pressure target automatically or to maintain same easily. This is particular important if there is a material variability in the area being worked. For example, besides having to monitor pressure and forward velocity, the operator must be aware of the entirety of operations of other persons or crew on the jobsite, the nature and distance of the processing done thus far, the depth of cut, the nature of the materials being cut, any transitions—hidden or otherwise—in such materials and any number of further operational variables.

The demonstration video for the product noted in the Risi patent and the documents on the product website also shows a particular phenomenon that is a major drawback of this system, where the forward motion of the machine gets into a type of oscillation due to the loading on the working machine, here a planer. The motion results from the inability of the operator controls or interface elements to have fine control over the advancement adjustments and an oscillation effect from the human interface with these elements, e.g., the lateral jerking motion of the cab mounted controls and operator. In the hands of an unskilled operator, the oscillation could even get to the point that the jerking motion of the operator's own body intensifies the magnitude of the oscillation of the machine. In either case, this oscillation creates load spikes on the attachment and uneven material processing which the product cannot attenuate.

Another example of an attempt to address this can be seen in U.S. Pat. No. 8,128,177 B2 to Menzenbach et al. In the subject patent, flow or pressure of the processing motor is not considered, the control focusing solely on the reaction forces exerted by the ground surface on the milling drum as a means to change the positive power applied to the advance drive of the machine to reduce lurching in either forward or reverse direction. The reaction forces are measured through strain gauges on the frame or the milling drum housing. There are some illustrations of graphs with pressure, but these relate to static pressures in reactionary cylinders (hydraulic rams). These are external measurements of strain on the vehicle and attachment. This methodology of velocity control has significant drawbacks. Measuring forces exerted on mechanical assemblies through strain gauges or pistons are not always reliable as there can be residual stresses in weldments and frames caused by misuse or temperature changes.

Ultimately, the primary drawback of the '177 device is that the load being applied to the processing motor can be very inaccurately measured and the actual load different when compared to these residual stresses and environmental variables interfering with the measurements. This device does not provide for or monitor the efficiency of the working device or attachment directly but is measuring the force applied to the attachment relative to the work surface, e.g., contact pressures. This coupled with the inaccurate nature of the measured forces and inability to recognize variances in processed material density results in no meaningful way of maintaining efficiency, just adjustment for relative stress measured through the attachment relative to the work surface. Finally, if the attachment is changed out on the device or to another device, the values known will be different, e.g., as between different types/models of the same attachment as well as between different types of attachments which may have different strains all together, the device is rendered useless.

A still further tool specific example is seen in US Patent Publication US20130341996A1 by Franzmann et al. This reference describes a device that uses force as an input to control the height of the sealing element that houses the cutting drum. Although changing the height will change the amount of material being processed and can be used to provide consistent feed rates, it also means an inconsistent depth of processing or cutting-something which is not desirable. It results in uneven surfaces. It does not address the measurement of the efficiency of the attachment or provide for mechanisms to maintain or adjust the vehicle speed to maintain such efficiency.

Variability in processed material density is also not recognized or capable of being compensated for in the operation.

One attempt at integrating a speed control device on a Cold milling Machine is discussed in “Practical Control of a Cold Milling Machine using an Adaptive PID Controller” (Meng et al., 2020). In this paper, the authors utilize a Proportional Integral Derivative (PID) Controller to regulate the feed rate of the vehicle to maintain an optimum engine RPM. The reference assumes a motor RPM at an ideal setting which is only true for situations where the engine is directly connected to the cutting implement. In the case of the system in the Meng reference, the engine being optimized is the diesel engine, trying to maximize efficiency of the diesel motor on a typical power curve for an internal combustion engine. The power of the engine is transferred via gear boxes to the drum in question. Though components of the drum subsystem are used in the optimization algorithms disclosed, Meng is not focused on the work done at the attachment or optimizing that output and if the proposed algorithm schema were used in a hydraulic circuit, it could easily incorrectly optimize the RPM.

When the power from such an engine is transferred to a ‘fused’ system like a hydraulic circuit with pressure relief valves, as described below in the exemplary embodiment of this invention, it becomes more important to maintain the flow and/or pressures within an optimal setting than to maintain an ideal engine RPM using feed rate. One of ordinary skill in the art will quickly understand that maintaining an ideal engine RPM will have no impact the moment a pressure relief valve is activated since at this point, the engine will ‘release’ the load through the pressure relief valve and spin, producing no work as designed but certainly easily maintaining the ideal engine RPM. A need exists for a machine or attachment capable of optimizing productive work at the machine or attachment level governed using more accurate and more universally applicable variables. Such a machine must do more than simply maintain RPM/engine speed. The cited paper does not provide such a machine nor fairly teach such a device. Additionally, with variable displacement hydraulic motors and pumps, the correlation with engine RPM becomes even more disconnected.

Thus there exists a need to provide a more accurate and efficient control system and device that measures load on the drive and working motor systems more accurately for an industrial device or vehicle with an attachment to permit the device to automatically regulate the speed of the industrial device or vehicle through measurement of power or pressure alone, flow alone, or pressure in combination with flow rate of the drive motor and working motor systems and adjust the feed rate by adjusting forward velocity of travel of the device or vehicle to maximize efficiency of the attachment.

A further need exists for an improved controller that utilizes sensor measurement directly of the working vehicle or industrial device with direct control of the power systems, for example the hydraulics, removing the need for operator monitoring and adjustment of controls to maintain maximum work from the tool. The result being similar to the speed limiter function in vehicle speed controllers, pushing control inputs to set the speed of the vehicle at an optimum rate and then provide for incremental adjustment of the speed via electronic input. The input is sent to the controller and the controller responds to the input based on values or mapped algorithms for at least the measured hydraulic pressure sensed at the tool or attachment or, in a further embodiment, providing similar incremental adjustment via electronic input to the controller based on mapped algorithms sensing at least flow, pressure or pressure and flow or the electric analog at the tool or attachment. More advanced features can further include AI learning that identifies optimum performance settings which then define, change, and update the mapped algorithms.

Yet a further need exists to provide a device that would be small enough to be mounted on multiple interchangeable tools, devices or attachments or included in dedicated vehicles to measure these inputs and produce a control output optimizing tool work performance. The resulting device would provide for decreased maintenance costs, decreased operating costs, more efficient production and reduced time to complete work. The device adds a heretofore unknown degree of “smart” controller operation to the tool which also means operators with less experience can achieve better performance.

An exemplary embodiment of such an invention would address the existing problems with the state of the art by measuring the pressure and/or flow and/or power going to an attachment or equivalent processing element in an industrial vehicle or device and potentially the power being produced by the motor or motors in the exemplary embodiment and the drive motor of a vehicle or an industrial device with the working attachment and provides output of information to a controller for the device or vehicle which automatically adjusts the speed of travel of the device or vehicle to adjust the supply speed to the working attachment, e.g. the feed rate, such that the optimum performance of the working attachment is achieved. Additionally, the measurement of the power at the motor allows for improved sampling and can be used to address uncontrolled oscillations found in existing systems as well as maintain and reinforce current automated safety protocols.

There exists a further specific need to provide such a control in a skid steer or similar industrial vehicle that typically mounts a working attachment or tool, such as but certainly not limited to a planer, wheel saw, trencher, or other cutting or earth working attachment. The hydraulic motor system controlling the working attachment is monitored for pressure and flow to facilitate control and efficient operation. This is coupled to control of the advancement speed of the industrial vehicle so as to maintain an optimum feed rate of material into the working attachment without varying depth of cut, rotational speed, or similar variables, just the forward motion of the vehicle to maintain work output relative to available power from the vehicle.

### SUMMARY OF THE INVENTION

An aspect of the invention is to provide an automated controller that controls the speed of the industrial device or construction vehicle based directly on how much the processing motor is being worked at the attachment.

A further aspect of the invention is an add-on retrofit kit for attachment to existing devices with speed management or speed creep controls which adjust through simple user inputs the vehicle speed, the kit coupling to and replicating these inputs in reaction to sensed variables representing the instantaneous work done at the tool, programmed or stored maximum work values, and control elements to automatically adjust the sensed variables to achieve and maintain this maximum work value as a function of the sensed variables.

Yet another aspect is to provide a control system that can significantly improve through automated adjustment and feedback the operating efficiency of an industrial device or construction vehicle even with an operator with limited experience or skill.

A still further aspect of the invention is a decreased maintenance cost due to the optimization of the operation of the equipment at peak performance, and conversely not being abused by the operator, by regulating the performance of the processing or working equipment with respect to the speed of industrial device or construction vehicle and maintaining maximum efficiency in the operation of the instant invention.

An aspect of the invention is to provide a device that is small enough that it can be mounted in various locations and is not as sensitive to abuse as strain gauged structures.

Another aspect is a device including a purpose-built controller having pre-programmed or user programmed variables and the ability to adjust the values in software for other aspects affecting efficiency, such as, but certainly not limited to, tool life, specific applications and materials, and the like.

Yet another aspect of the invention is to provide a construction vehicle, such as but not limited to a skid steer loader, with an operating attachment such as, but certainly not limited to, a planer, wheel saw, or other attachment and controlling the velocity of the construction vehicle automatically in response to the sensed measure of the power being used or work being done and at the attachment.

Another aspect of the invention is a controller that controls the speed of an industrial device or vehicle such as, but certainly not limited to, a tractor, a mower, or similar industrial device or vehicle using for instance, but not limited to, hydraulic, electric or similar motors, which require optimum cutting blade speeds relative to a material infeed or feed rate that can be adjusted by the velocity of the industrial device or vehicle to work the material processing speeds as efficiently as possible.

A further aspect of the invention is to provide sensors at or near the attachment or working device to locally and instantaneously measure the pressure of the hydraulic load on the attachment so as to report the instantaneous pressure to a controller to vary the infeed or movement rate of the industrial vehicle or device automatically to optimize the work done by measuring the pressure in the operation and maintain that pressure within an idealized range.

A still further aspect of the invention is to provide sensors in one exemplary embodiment at or near the attachment or working device to locally and instantaneously measure the flow rate of the hydraulic fluid to the machine under load so as report the instantaneous flow rate to a controller to vary the infeed or movement rate of the industrial vehicle or device automatically to optimize the work done by measuring the flow rate in the operation and maintain that flow rate within an idealized range.

Yet a further aspect of the invention is to provide sensors at or near the attachment or working device to locally and instantaneously measure the pressure and flow rate of the hydraulic tool so as to report the instantaneous pressure and flow rate to a controller to vary the infeed or movement rate of the industrial vehicle or device automatically to optimize the work done through the measurement of the pressure and flow rate in the operation and maintaining the pressure and flow rate within idealized ranges.

The invention includes a method, an apparatus, and an article of manufacture for controlling an industrial device or vehicle with an attachment.

The apparatus of the invention includes a vehicle or industrial device or machine having an attachment mounted thereon, the attachment performing work upon a work piece or work surface, including a vehicle or machine frame with an at least one power system providing power to the attachment. An at least one sensor senses an input representing the power provided the attachment with an at least one controller adapted to calculate the work done at the attachment based on the power provided the attachment and maintaining the power to a stored or programmed efficient target value based on the adjustment of the feed rate of the work piece or work surface to the attachment. The apparatus of the invention further includes a skid steer loader having a planar attachment coupled thereto, having a skid steer loader frame, an attachment frame; a skid steer loader drive engine powering the skid steer loader and providing a forward velocity for the skid steer loaded. An at least one hydraulic system having an at least one hydraulic motor powered by the drive engine and powering the attachment is provided, with an at least one hydraulic manifold coupled to the at least one hydraulic system with an at least one attachment hydraulic line powering an at least one attachment hydraulic motor powering the working element of the attachment. An at least one sensor sensing is provided with an at least one input in the at least one hydraulic line powering the at least one attachment hydraulic motor. A controller is included where the controller is adapted to receive the sensed at least one input from the at least one sensor and correlate the at least one input to the work being done at the attachment and to maintain the at least one input in an optimum range and thereby optimize the work output of the attachment upon a work surface.

The loader controller can further adjust the work being done at the attachment by adjusting the forward velocity of the skid steer loader and thereby the feed rate of material to the attachment The at least one sensor sensing an input in the at least one hydraulic line can sense at least one of a pressure, a flow, a flow and a pressure. The at least one sensor sensing the at least one input in the at least one hydraulic line can further sense at least one pressure of the working element of the attachment.

The skid steer can further comprise an at least one further measured variable sensed by the at least one sensor or from a further at least one sensor, the at least one further measured variable being at least one of a hydraulic fluid flow rate, a hydraulic fluid temperature, a hydraulic fluid flow, a variable displacement setting in the hydraulic system, torque at the working element, orifice sizes, the pressure difference between the inlet and outlet of a hydraulic manifold, external or ambient temperatures, rotation speed of cutting head and gauge pressure. The controller can adjust the forward velocity based on the at least one input in combination with the at least one further sensed variable to optimize work at the attachment. The controller can further adjust the forward velocity based on the at least one input in combination with the at least one further sensed variable and calculates the target values for the optimization of the work output of the attachment as sensed by and adjusting to maintain the sensed at least one input and further sensed variables in computed optimized ranges. The skid steer can further comprise an at least one PID controller to control the at least one sensed input within the mapped optimized range. The skid steer can also include a further PID controller to control the at least one further measured variable.

The skid steer of claim can further comprise an at least one user programmable input. The at least one user programmable input is at least one of a model designator, a displacement, material variables, a tool life estimate, at least one input related to the working surface material or surface composition, material consistency or specific descriptors related to the processing tools or attachment, outdoor temperature, hours in service, an at least one variable representing tool wear, processed area, density, toughness, and strength of the surface material. The operating attachment can be a planer, mower, tiller, soil conditioner, trencher, snow blower, or wheel saw.

The controller can access a stored, mapped performance curve or surface based on a sensed variable chosen from at least one of pressure, flow, or pressure and flow to set an optimal efficiency target for the work being done at the attachment and determining with the at least one sensed variable where the current operation is relative to that curve and adjusting to move toward the optimized value of the sensed variable. The controller can have an at least one machine learning element, wherein the machine learning element adjusts the stored, mapped performance curve or surface. The skid steer can have an at least one machine learning element that interrogates, stores, and adjusts the performance curve or surfaced based on historical sampling of the at least one sensed variable.

A still further apparatus of the invention includes a vehicle having an attachment mounted thereon, the attachment performing work upon a work piece or work surface, the invention including a vehicle frame, an attachment frame; an at least one attachment power system providing power to the attachment; an at least one sensor sensing an input representing at least a direct correlation to the work done at the attachment; and an at least one controller. The controller is adapted to calculate the work done at the attachment based on the at least one sensed input as the attachment performs work upon the work piece or work surface and maintaining the input at a calculated optimized value.

The vehicle further comprising an at least one hydraulic system coupled to and powering the attachment. An at least one hydraulic manifold can be coupled to the hydraulic system and an at least one attachment motor, the at least one attachment motor driving the attachment. The vehicle can further include an at least one sensor sensing an input in the at least one hydraulic line senses at least one of a pressure, a flow, a flow and a pressure in the hydraulic system, the at least one hydraulic manifold or the at least one attachment motor as the at least one sensed input. The at least one sensor can sense the at least one pressure in the hydraulic system, the at least one hydraulic manifold or the at least one attachment motor as the at least one sensed input.

The controller can adjust the work being done at the attachment by adjusting the forward velocity of the vehicle and thereby the feed rate of material to the attachment and this in turn changes the sensed at least one pressure. An at least one further measured variable can be sensed by the at least one sensor or a further at least one sensor, the at least one variable being a hydraulic fluid flow rate, a hydraulic fluid temperature, a hydraulic fluid flow, a variable displacement setting in the hydraulic system, torque at the working element, orifice sizes, the pressure difference between the inlet and outlet of a hydraulic manifold, external or ambient temperatures, rotation speed of cutting head and gauge pressure.

The controller can also adjust the work done based on the at least one input in combination with the at least one further sensed variable to optimize work at the attachment. The at least one controller can control the velocity of the vehicle automatically in response to the sensed measure of the work being done by the attachment.

The power system can be electric and further comprise an electric motor or electro magnet to provide power to the attachment. The vehicle can be one of a lawn mower, tractor, tiller, excavator, dozer, self-propelled saw, tracked loader, wheeled loader, dozer, vehicle with a bundler, landscape rake, mulcher, stone crusher, sifting vehicle, planer, beach cleaner, soil conditioner, snow blower, stump grinder, flail mower, rotary mower, wheel saw, asphalt saw cutter, trencher, and planer. The attachment can be one of a lawn mower, a tiller, an excavator, a saw, a bundler, a landscape rake, a mulcher, a stone crusher, a sifting devices, a planer, a beach cleaner, a soil conditioner, a snow blower, a stump grinder, a flail mower, a rotary mower, a wheel saw, an asphalt saw cutter, and a trencher.

The apparatus of the invention further includes an industrial device or static machine having an attachment mounted thereon, the attachment performing work upon a work piece or work surface, having a frame; an attachment frame; an at least one attachment power system providing power to the attachment; an at least one sensor sensing an input representing at least a direct correlation to the work done at the attachment; an at least one controller adapted to calculate the work done at the attachment based on the at least one sensed input as the attachment performs work upon the work piece or work surface and maintains the input at a calculated optimized value.

The apparatus of the invention also includes an add-on or retrofit kit for an existing attachment which couples to a vehicle mounting the attachment with speed management or speed creep controls, the kit having an attachment frame; a hydraulic manifold coupled to a hydraulic system of the vehicle and having an at least one hydraulic drive motor; an at least one sensor sensing an at least one variable of the at least one hydraulic drive motor or hydraulic manifold, the sensed variable correlating to the work output of the attachment; and an attachment controller, wherein the at least one variable is sensed and reported to the controller and compared to an optimized working range for the variable, the attachment controller is adapted to send a signal to control the speed of the vehicle utilizing the speed management or speed creep control signals to control the speed of the vehicle and thereby the feed rate of material to the attachment and thereby control the work done by the attachment by maintaining the at least one variable in the optimized working range.

The at least one user input can be set by a user of the vehicle. The at least one user input can further include at least one of an input that: sets initial vehicle speed, sets or accesses or calculates maximum work values for the attachment, and control elements to automatically adjust the sensed variables to achieve and maintain this maximum work value as a function of the sensed variables. The at least one sensor sensing a variable can sense at least one of a pressure, a flow, a flow and a pressure in the hydraulic system, the at least one hydraulic manifold or the at least one attachment motor as the at least one sensed input. The at least one sensor can further sense the at least one pressure in the hydraulic system, the at least one hydraulic manifold or the at least one attachment motor as the at least one sensed input. The controller can also adjust the forward velocity of the vehicle and thereby the feed rate of material to the attachment in turn changes the sensed at least one pressure.

The kit can further include an at least one further measured variable sensed by the at least one sensor or a further at least one sensor, the at least one variable being from the group comprising at least one of a hydraulic fluid flow rate, a hydraulic fluid temperature, a hydraulic fluid flow, a variable displacement setting in the hydraulic system, torque at the working element, orifice sizes, the pressure difference between the inlet and outlet of a hydraulic manifold, external or ambient temperatures, rotation speed of cutting head. The controller can adjust the work done by the attachment based on the at least one input in combination with the at least one further sensed variable to optimize work at the attachment.

The vehicle can be one of a lawn mower, tractor, tiller, excavator, dozer, self-propelled saw, tracked loader, wheeled loader, dozer, vehicles with bundler, landscape rake, mulcher, stone crusher, sifting vehicle, planer, beach cleaner, soil conditioner, snow blower, stump grinder, flail mower, rotary mower, wheel saw, asphalt saw cutter, trencher, and planer. The attachment can be one of a lawn mower, a tiller, an excavator, a saw, a bundler, a landscape rake, a mulcher, a stone crusher, a sifting device, a planer, a beach cleaner, a soil conditioner, a snow blower, a stump grinder, a flail mower, a rotary mower, a wheel saw, an asphalt saw cutter, and a trencher or combinations thereof.

The apparatus of the invention further includes a controller controlling an industrial device or vehicle based directly on a calculated estimate of work being done at the working element of an attachment. The controller includes a programmable logic controller, a data storage device coupled to the controller, an at least one sensor sensing at least one variable that is used to calculate the estimate of work being done at the processing motor, an at least one output controlling an at least one parameter that increases or decreases proportionately with the at least on variable and thereby increases or decreases the calculated estimate of work done at the processing motor, wherein the controller is adapted to calculate the estimated work done by receiving the at least one variable sensed by the at least one sensor, calculating an estimate of work, comparing this calculated value against an optimal calculated value and adjusting the at least one output through the increase or decrease of the at least one output and thereby the at least one parameter to adjust the estimate of work.

The automated controller can further include an at least one hydraulic system wherein the processing motor is a hydraulic motor coupled to the at least one hydraulic system. The controller can further comprise an at least one electric system wherein the processing element is electrically powered and coupled to the at least electric system. The at least one variable can be at least one of pressure, flow, and pressure and flow. The at least one variable can be at least one of pressure. The optimal variable calculated can be calculated as a lookup table stored in the data storage as part of a map or surface. The optimal variable can be adjusted by further inputs. The automated controller further inputs include at least one of time in service, wear factor, material composition, temperature, a hydraulic fluid flow rate, a hydraulic fluid temperature, a hydraulic fluid flow, a variable displacement setting in the hydraulic system, torque at the working element, orifice sizes, the pressure difference between the inlet and outlet of a hydraulic manifold, external or ambient temperatures, rotation speed of cutting head. The at least one output can be a feed rate of material to the attachment. The feed rate of material to the attachment can be adjusted by the increase or decrease in the speed of a vehicle to which the attachment is coupled by the controller.

An attachment controller is a further apparatus of the invention, the attachment controller controlling the work done by an attachment, the controller having a programmable logic controller (PLC); a memory storage device coupled to and communicating with the PLC; an at least one sensor transmitting as an input and providing sensor data correlating to the work done by the attachment and coupled to and communicating with the PLC; and an at least one output controlling an at least one parameter that increases or decreases the feed rate of material to the attachment, wherein the PLC is adapted to measure the least one variable at a working element of the attachment such that the at least one sensor measures at least a pressure as a variable that corresponds to a calculated estimate of the work done at the attachment and the output is thereby increased or decreased toward an optimal value determined by the controller.

The attachment controller further includes an at least one additional sensor sensing an additional variable. The additional sensed variable can be an at least one flow within the attachment. The at least one sensed flow can be used with the at least one pressure to calculate the estimate of work done at the attachment. The attachment controller further includes an at least one further sensor input including at least one further sensed variable, the further sensed variable being at least one of a hydraulic fluid flow rate, a hydraulic fluid temperature, a hydraulic fluid flow, a variable displacement setting in the hydraulic system, torque at the working element, orifice sizes, the pressure difference between the inlet and outlet of a hydraulic manifold, external or ambient temperatures, rotation speed of cutting head and gauge pressure. The further sensor inputs can be used by the controller in determining the optimized value.

The PLC of the controller can be further adapted to operate the attachment and monitor the at least one sensor input and compare the at least one sensor inputs to stored parameters representing an optimized target value stored in the memory storage device for the sensed pressure and adjusting the operation of the attachment and the at least one parameter based on the sensor data and thereby the work done by the attachment in real time. The controller can further include a user interface and an at least one user programmed variable, the controller being further adapted to utilize the at least one user programmed variable to adjust the calculation of the estimate of work and to adjust the values used to calculate the estimate of work.

The method of the instant invention includes a method of operating a hydraulic attachment tool on a vehicle to optimize work done at that attachment, the method comprising the steps of: starting a startup cycle when the attachment or vehicle is engaged; obtaining an optimum pressure as an input; obtaining a maximum pressure as an input; sensing an at least one pressure as an input from an at least one sensor; comparing the at least one pressure to the max pressure, if it is greater than or equal to the max pressure then the comparing step proceeds directly to a step to lower the forward velocity of the vehicle and thereby the feed rate of material to the attachment and the sensed pressure, a further comparison step comparing the sensed pressure to the optimum pressure, if the sensed pressure is greater than or equal to the optimum pressure or a bound of the optimum pressure the controller maintains the velocity of the vehicle through a cycle time and upon completion of the cycle time performs a still further comparison step whereby if the sensed pressure reading in the still further comparison step is equal to or within a defined bound of the optimum pressure, it simply resets to sample again, but if the sensed pressure exceeds the optimum pressure or a defined bound of the optimum pressure proceeds to a further step to incrementally reduces velocity, and; if the sensed pressure is less than the optimum pressure or less than the defined bounds around the optimum pressure proceeds to a further step to incrementally increase velocity; and returning to the sensing step after either incrementing velocity step occurs while the attachment remains in operation, wherein the method continues during the operation of the attachment and continually optimizes the work done at the attachment based on the sensed at least one pressure.

The startup cycle can further comprise the step of receiving an at least one user selected input. The user selected input can be at least one of an input that sets initial vehicle speed, sets or accesses or calculates maximum optimized work values for the attachment, and control elements to automatically adjust the at least one sensed variable to achieve and maintain this maximum work value as a function of the sensed variables. The at least one user selected input can be at least one of oil temperature, cutting element velocity, attachment RPM, attachment temperature, attachment torque, vehicle and/or attachment drift velocity or vectors, attachment angle of attack, inclination of work surface being traversed, sensor data representing wear on the vehicle or attachment or both, manual inputs representing wear or condition of the equipment including but not limited to for example time in service, blade sharpness, time on job, and material variables for a material being worked upon.

The method step of obtaining the optimum pressure as an input can further include calculating an optimum pressure from an at least one input. The method step of obtaining the optimum pressure as an input can further comprise accessing a data storage device and referencing an at least one variable in conjunction with a look up table. The at least one sensor can be coupled to a hydraulic system, the at least one sensor measuring pressure at the working element of the attachment. The sensed pressure can be used by the controller to calculate the estimated work output at the working element. The method can further comprise the step of indicating in a display panel an indicator of the status of the work being done at the attachment, the resulting velocity, and the relative velocity to that of the calculated maximum work target. The sensing step can further include sensing with the at least one sensor a pressure and at least one further variable.

The at least one further measured variable can be at least one of a hydraulic fluid flow rate, a hydraulic fluid temperature, a hydraulic fluid flow, a variable displacement setting in the hydraulic system, torque at the working element, orifice sizes, the pressure difference between the inlet and outlet of a hydraulic manifold, external or ambient temperatures, rotation speed of cutting head and gauge pressure. The step of obtaining an optimum pressure can include retrieving data from at least one database, stored in memory, and an operator input representing the optimum pressure.

The method step of obtaining if the optimum pressure further includes determining if the optimum pressure is stored on the at least one database or stored in memory after being calculated from a single variable function or as a multivariate mapping of a performance curve or curves. The method further comprises an adjustment step wherein following the step of obtaining the optimum pressure, the value of the optimum pressure is provided, and the adjusted data stored as optimum pressure data for retrieval by a user.

The at least one pressure sensor can also provide real time data reporting at the sensing step for a sensed pressure to the controller and a further storage step storing historical real time data during operation. The step of incrementally increasing the velocity can further comprise the steps of sending the throttle input from through a user control to increase the velocity. The step of incrementally increasing velocity can further include sending a signal from the attachment to the SMU of the industrial vehicle.

The method of the invention further includes a method of controlling an attachment having an attachment work optimizing controller and coupled to a vehicle, comprising the steps of: engaging an attachment; conducting a startup sequence; setting user inputs using a user interface; engaging the attachment to work on a work surface; sensing with an at least one sensor an at least one variable representing an estimate of the work done through a working element of the attachment working upon the work surface; calculating an estimated work value for work done at the attachment from the at least one sensor; comparing the estimated work value to an optimized work target for the work done at the attachment; controlling an output, wherein the output is adjusted by the controller and effects the at least one variable so that the estimated work value remains within a defined bounded value around the target optimized work value.

The attachment can have a motor and can be driven by an at least one hydraulic system. The sensed at least one variable can be an at least one of a pressure, a flow, and a pressure and a flow. The sensed at least one variable can be an at least one pressure. The output can be the velocity of the vehicle which directly affects the feed rate of the work surface. The method can further include the method step of storing the calculated sensed at least one variable, the calculated work estimate, and the optimized work target in a memory storage device.

The method can further include the step of calculating from the user inputs the optimized work target. The attachment can be at least one of a is one of a lawn mower, a tiller, an excavator, a saw, a bundler, a landscape rake, a mulcher, a stone crusher, a sifting devices, a planer, a beach cleaner, a soil conditioner, a snow blower, a stump grinder, a flail mower, a rotary mower, a wheel saw, an asphalt saw cutter, and a trencher. The method step of setting user inputs can further comprise accessing an at least one database of variables. The method step of setting user inputs can further comprise accessing the database for limits for the attachment or a material being worked upon or both.

The apparatus of the invention includes a skid steer loader having a planar attachment coupled thereto, comprising: a skid steer loader frame. An attachment frame having a skid steer loader drive engine powering the skid steer and the attachment and providing a forward velocity for the skid steer loader. An at least one hydraulic system having an at least one hydraulic motor powered by the drive engine is provided. An at least one hydraulic manifold coupled to the hydraulic system with an at least one attachment hydraulic line powering an at least one attachment hydraulic motor on the attachment with an at least one sensor sensing an input in the at least one hydraulic line powering the at least one attachment hydraulic motor is also included with a controller. The controller is adapted to receive the at least one input from the at least one sensor and correlate the at least one input to the work being done at the attachment and adjust the work being done at the attachment by adjusting the forward velocity of the skid steer loader to maintain the at least one input in an optimum range and thereby optimize the work output of the attachment.

The apparatus and method of the invention further includes an attachment controller controlling an attachment, the controller having a programmable logic board with a memory storage device. An at least one sensor input providing sensor data correlating work done by the attachment is provided with an at least one output controlling an at least one parameter that changes the at least one sensor input to increase or decrease the work done by the attachment, wherein the programmable logic board has software programmed on it that executes an at least one program to operate the vehicle and monitor the at least one sensor inputs and compare the at least one sensor inputs to stored parameters representing an optimized target value stored in the memory storage device and adjusting the operation of the attachment and vehicle and the at least one parameter based on the sensor data and thereby the work done by the attachment.

In a modified embodiment, the controller integrates one or more Proportional, Integral and Differential (PID) controllers or processing elements in the controller. The PID controller logic performs error correction to maintain the optimal performance settings which can be defined using machine learning and/or manual inputs by the operator and/or stored parameters as previously mentioned for the variables instantaneously measured.

Moreover, the above objects and advantages of the invention are illustrative, and not exhaustive, of those which can be achieved by the invention. Thus, these and other objects and advantages of the invention will be apparent from the description herein, both as embodied herein and as modified in view of any variations which will be apparent to those skilled in the art.

### BRIEF DESCRIPTION OF THE DRAWINGS

Embodiments of the invention are explained in greater detail by way of the drawings depicting non-limiting exemplary embodiments, where the same reference numerals refer to the same features.

FIG. 1 shows a side view of an exemplary embodiment of the instant invention as realized in a skid steer having a planer attachment coupled thereto.

FIG. 2 shows a further front view showing the exemplary embodiment of FIG. 1.

FIG. 3 shows a side view of the planer attachment attached to the embodiment of FIG. 1.

FIG. 4a shows a front view of an exemplary embodiment of the manifold of the attachment of FIG. 1.

FIG. 4b shows a front view of an alternate exemplary embodiment of the manifold used in the attachment of FIG. 1.

FIG. 5a is a is a plan view of the exemplary embodiment of FIG. 1, showing the hydraulics, vehicle control, sensor and other sub-systems of the exemplary embodiment of FIG. 1.

FIG. 5b shows a plan view of an alternate exemplary embodiment of the invention incorporated into an existing vehicle with a vehicle Speed Management Unit (SMU).

FIG. 6 is a plan view of the control inputs and outputs of the exemplary embodiment of FIG. 1.

FIG. 7 shows a flow chart of an exemplary embodiment of the logic used in the smart attachment control system utilizing input from a flow sensor.

FIG. 8 shows a flow chart shows a flow chart of an exemplary embodiment of the logic used in the smart attachment control system utilizing input from a flow sensor and a pressure sensor.

FIG. 9 shows a plan view of a further exemplary embodiment of the instant invention replicating vehicle control speed inputs.

### DETAILED DESCRIPTION OF THE INVENTION

The invention comprises an industrial vehicle or manufacturing equipment having a working device or attachment with at least one industrial vehicle speed control or infeed speed controller component governing speed through inputs and outputs, colloquially a controller, sub-controller, or algorithm governing speed, often referred to, in a non-limiting example, as a Speed Management Unit (SMU) in the construction vehicle industry, and a pressure and/or flow sensor input from the working device or attachment communicating with said controller component.

Using the non-limiting example of a construction vehicle as an industrial vehicle, the existing SMU governs speed and is adjusted manually to move the vehicle around a job site. The SMU typically receives input from an operator in the cab of the vehicle, these inputs governing speed during movement and during operations with the attachment on the vehicle for instance. The instant invention reads information from sensor(s) detecting at least one parameter that represents work being done at the attachment, the results of which are sent to the controller in the exemplary embodiment of the invention. Based on specific mapping of the at least one sensed parameter as it relates to hydraulic, electric or attachment power and system performance or work as it is stored on the controller or accessible by the controller. This mapping provides boundary conditions accessible on the controller or in storage that is updatable as well as providing for the additional or pre-programmed or user defined inputs and adjustments of these existing values. Based on the stored performance curve or surface data, a determination is made by the controller based on at least one sensed parameter(s) as compared against the mapped, stored and/or adjusted parameters to determine whether the current operation of the working device is optimal.

Directly affecting change in pressure through changes in forward or feed velocity and thereby load, results in direct changes in the pressure, and/or changes in the flow in the hydraulic motor managing the working element so as to optimize the work output without passing boundary conditions in the operation of the system and causing the pressure relief valve to release. This operation is distinguishable in that in the instant invention this is directly measuring at the working element the pressure provided by the hydraulic system which provides a more accurate and timely status of the machine and can take into account a wider variety of sensed variables in optimization of operations of the machine or attachment.

As is known in the art, hydraulic power (horsepower output) is a product of flow, pressure, temperature, and efficiency. Thus, sensing pressure at the tool can be used to work back to optimization values for work via such power calculations. Factors specific to that type of machine and even specific to that particular machine and its motors and its wear condition can be accommodated in the optimization calculations. In a first embodiment on a planning machine as shown, the forward velocity of the system can be isolated as a principal input affecting the sensed pressure at the tool. Further inputs can be added to this and further embodiments, including but not limited to oil temperature, cutting element velocity, attachment RPM, attachment temperature, attachment torque, vehicle and/or attachment drift velocity or vectors, attachment angle of attack, inclination of work surface being traversed, sensor data representing wear on the vehicle or attachment or both, manual inputs representing wear or condition of the equipment including but not limited to for example time in service, blade sharpness, time on job, and material variables for a material being worked upon

This determination within the controller and the method of operation executed by the controller in an exemplary embodiment of the instant invention provides for an output that adjusts the forward rate and thereby the rate of feed to the attachment to maintain the operation at or near the optimal values, e.g. if the vehicle needs to go faster or slower based on the sensed parameter data at the attachment or working device the controller can automatically adjust the infeed speed and thereby adjusts the work being done at the working device or attachment with the monitoring of the measured or sensed values, e.g. pressure, flow, pressure and flow for instance. By targeting the sensed value that is related through known equations for work output, the optimization can be targeted and maintained, e.g. by maintain the sensed values at an optimized target the work done is known through calculation and can be maintained as well. In this fashion, the instant invention works to optimize the operation of the working device without the need for operator input. In the simplest version the direct relationship of pressure to work output with a known displacement and therefore flow can be used to correlate pressure and work directly from the known equations for work in a hydraulic system.

The values of a variety of variables can be obtained as noted. Principally, in the exemplary embodiment of the instant invention disclosed in the accompanying drawings, a non-limiting example of a planar is provided. Like many attachments, the work done at the attachment is the direct product of the sensed input in this instance an at least one pressure measurement and changes in the resulting variables value, e.g. pressure, which are directly related to changes needed to optimize work output as is known to those of ordinary skill in the art. The pressure calculations made in the instant invention is distinct from solutions utilizing or measuring only engine RPM in that the pressure in a hydraulic system with a maximum or crack pressure and a pressure relief system can still maintain an RPM even when the pressure is dumped and not used for work. Thus, the instant invention, in the exemplary embodiment shown, is more accurate than and better capable of determining automatic adjustment of the work done at the working tool more readily and accurately than previous solutions. Sufficient to allow for automated optimization of the process. A driver for this in the case of the exemplary embodiment of the planar is the feed rate of the material which directly affects the pressure at the working attachment and thus the work.

In one of the exemplary embodiments described, the controller mimics the “FAST” and “SLOW” buttons (switches) operations which are already in the vehicle and sends these input pulses or ON-OFF commands through existing communication ports to the Speed Management Unit/controller. In a further exemplary embodiment, a more integrated solution implementing the instant inventions controller and programming is incorporated into the SMU of the vehicle or in a package within the attachment that couples to the SMU and control the speed directly in the programming of the SMU. Similarly, a still further embodiment could incorporate the instant invention into the programmed logic controller for a self-driving and/or self-operating programmable working device or industrial vehicle.

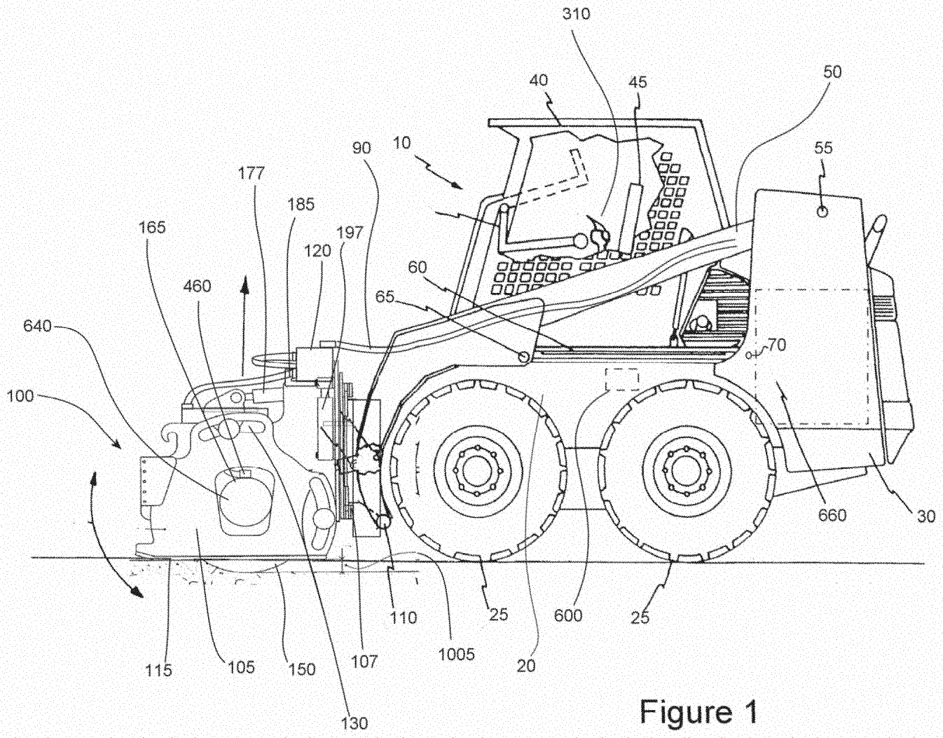

FIG. 1 shows a side view of an exemplary embodiment of the industrial device utilizing the attachment sub-system controller of the instant invention. A non-limiting exemplary embodiment of the manufacturing equipment or industrial vehicle of the instant invention is shown with respect to a loader or skid steer 10 described herein. However, it should be noted that the present invention can be implemented in other industrial vehicles or powered machines and the present invention is described herein with respect to the loader of FIG. 1 for illustrative purposes only. Additional industrial vehicles, devices, and/or attachments contemplated for the invention can include but are not limited to lawn mowers, tool carriers, tractors, tiller, excavators, self-propelled saws, tracked loaders, wheeled loaders, dozers, and similar devices or machines with bundlers, landscape rakes, mulchers, stone crushers, sifting devices, planers, beach cleaners, soil conditioners, snow blowers, stump grinders, flail mowers, rotary mowers, wheel saws, asphalt saw cutters, trenchers, planers and the like typically but not exclusively powered by the industrial vehicle.

Similarly, it is further shown in FIG. 1, herein again as a non-limiting example, the loader 10 is having what is typically referred to as a planing attachment as the working device or attachment 100, which is coupled to the skid steer or vehicle 10. Similarly, though referred to as an attachment, as noted above the instant invention can be incorporated into purpose-built vehicles with device elements similar to the attachments described for performing specific work that can be optimized. Further attachments can include but are certainly not limited to lawn mowers, tractors, tiller, tool carrier, excavators, self-propelled saws, tracked loaders, wheeled loaders, dozers, and similar devices, attachments with bundlers, landscape rakes, mulchers, stone crushers, sifting devices, planers, beach cleaners, soil conditioners, snow blowers, stump grinders, flail mowers, rotary mowers, wheel saws, asphalt saw cutters, trenchers, planers and the like as attachments to a vehicle or device.

Turning again to FIG. 1, the figure shows the side elevational view of skid steer loader 10 of the present invention. As discussed above, this is a non-limiting example and the exemplary embodiment of the instant invention can be deployed on any number of industrial vehicles or attachments or purpose built vehicles or industrial machines. The skid steer loader 10 of FIG. 1 includes a frame 20 supported by wheels 25. Frame 20 also supports a cab or operator compartment 40 which substantially encloses an operator seat 45 on which an operator O sits to control skid steer loader 10 and attachment 100. Cab 40 can take any shape desired and is illustrated with the shape shown for illustrative purposes only.

FIG. 1 also illustrates a plurality of hand controls or hand grips or joysticks 310 which reside within the operator compartment 40. Hand grips 310 preferably are provided with a number of actuators such as but certainly not limited to push buttons, potentiometers, switches, and the like which can be manipulated by the operator to accomplish certain functions. Additional control elements can include but are not limited to pedal inputs, control knobs, control switches, membrane keypads, touch sensitive screens, wireless keyboards or other input devices and the like. The operator actuates the inputs, in this instance on the hand grips or joystick 310 in the non-limiting exemplary embodiment provided prompting electrical signals to be communicated to a controller described in greater detail herein below. These signals are inputs for the functions of loader 10 and the attachment 100. In addition, one or more additional operator inputs and display panels can be provided in operator compartment 40. The operator can provide additional input on the display panels or the vehicle can indicate certain items of information to the operator and also provide additional operator inputs through the additional input devices, which can include but are certainly not limited to membrane keypads, touch sensitive screens, wireless keyboards or input devices and the like, through which the operator can provide the inputs to operate the loader 10 and/or the attachment 100 as well as provide further inputs to the controller.

It should, however, also be noted that inputs can be provided via mechanical or analog elements as well. For instance, hand grips can be coupled to levers which control valve spools or solenoids through mechanical linkages (not shown). Similarly, foot pedals (not shown) can be provided in operator compartment 40 which also control valve spools or solenoids through mechanical linkages. Additionally, secondary low pressure hydraulic systems can be employed, for example this is typical on excavators which have what is commonly referred to in the industry as Pilot controls i.e. a lower pressure hydraulic circuit going to joystick inputs that move the spools on the main hydraulic circuit. Other alternative controls provide for all electric and/or digital inputs. These control inputs can transmit similar signals as those previously enumerated. These signals can be hardwired or transmitted wirelessly or through known networks or similar wireless methods. These can include for example, but are certainly not limited to CANbus, CANopen, PROFIBUS, Ethernet, EtherCAT and other network integration solutions. Multiple programming platforms are also contemplated, for instance, those utilized by Delta, Allen Bradley, Weg, Wonderware, Emerson, and IFM Efector. In addition, remote or automated operation is also contemplated within the scope of the type and condition of the exemplary loaders of the instant invention, whereby the operator compartment would be replaced with automated control, communications and/or remote-control equipment.

In the exemplary embodiment depicted, a set of lift arms 50 is coupled to frame 20 at pivot points 55. Typically two arms work in conjunction with one another, though only one of the pair of arms is shown in the view depicted in FIG. 1, the other being identically disposed on the opposite side of loader 10. A pair of hydraulic cylinders 60 are typically mounted to the lift arms 50, again only one of which is shown in FIG. 1, and are pivotally coupled to the frame 20 at pivot points 70 and to lift arm 50 at pivot point 65. Lift arms 50 are also coupled to a working tool or attachment 100 which, in this exemplary embodiment, is but is certainly not limited to the planer as described above. Lift arms 50 are coupled to the planer attachment 100 at the mounting frame 110 as further described herein below. An attachment or auxiliary hydraulic line 90 is shown traveling down the lift arm 50.

While only one attachment hydraulic line 90 is shown, it is understood by one of ordinary skill in the art that any desired number of cylinders and lines could be used to work the attached planer or any other suitable tool without departing from the scope of the invention. Reference to the single additional set of attachment hydraulic supply lines is for illustrative purposes only. Further lines are contemplated and depend principally on the nature of the attachment 100. In the non-limiting exemplary embodiment shown, the single line is utilized for the planer. Similarly, though a single line is illustrated, hydraulic systems work on a circuit and an outflow line 99 to recover the fluid is provided. For clarity and brevity, reference to the return lines has been omitted in several of the figures, but it is understood that the circuits are complete within the system as well understood by one of ordinary skill in the art. Similarly, at least one hydraulic fluid reservoir is also implied within the system as described and, again, as would be well understood by one of ordinary skill in the art.

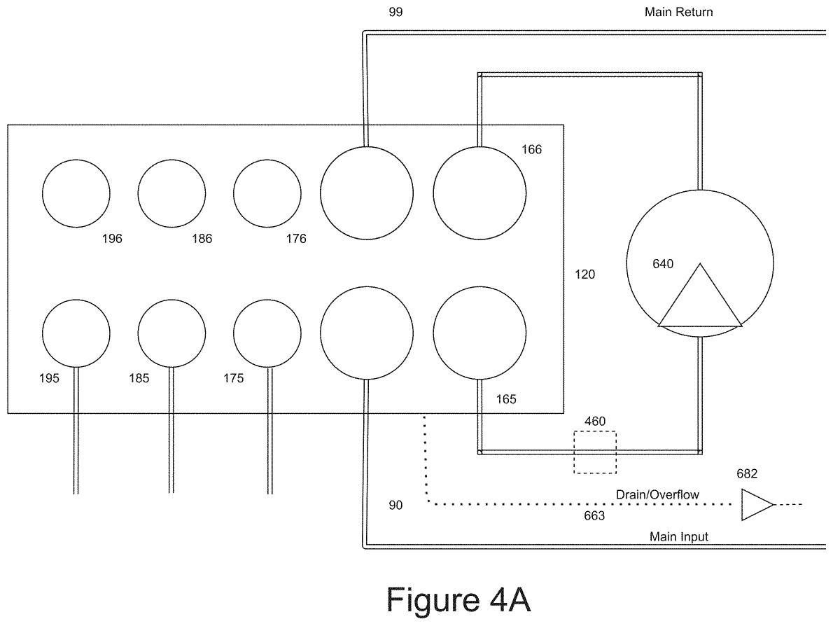

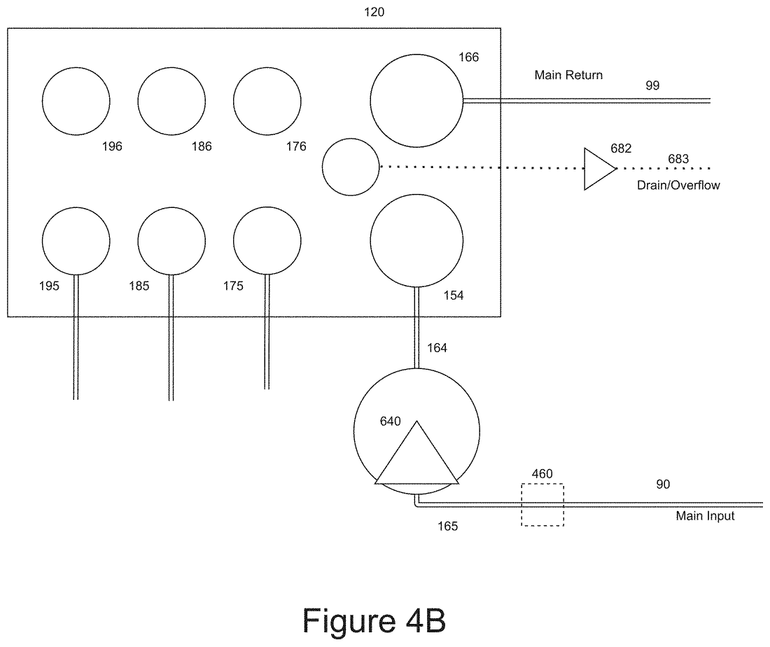

In addition, loader 10 illustratively has one or more auxiliary hydraulic couplings and further auxiliary hydraulic lines, as best shown in FIGS. 4A and 4B showing exemplary embodiments of the hydraulic manifold 120, which can be provided with quick disconnect type fittings. Hydraulic pressure to the arm hydraulic cylinder 60, any auxiliary hydraulic cylinders or lines 90, and the auxiliary couplings and lines that extend from the attachment manifold 120, collectively the hydraulic systems, are controlled based on signals from the one or more of the operator input devices within operator compartment 40 and powered by the prime mover or drive motor or principal motor 660. The drive motor 660 is located in the engine compartment 30 and shown in shadow. As described herein below, the drive motor 660 and hydraulic pumps drive the wheels 25 and the attachment 100.

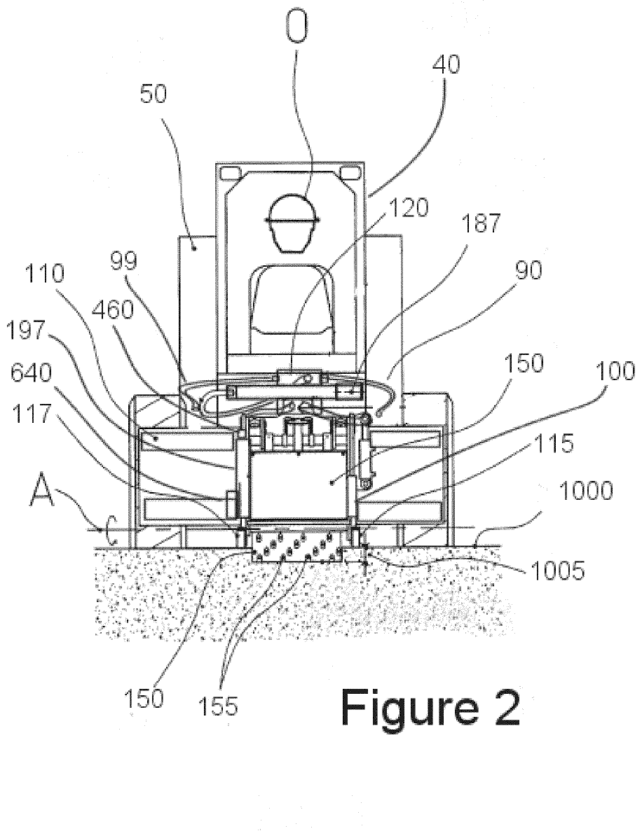

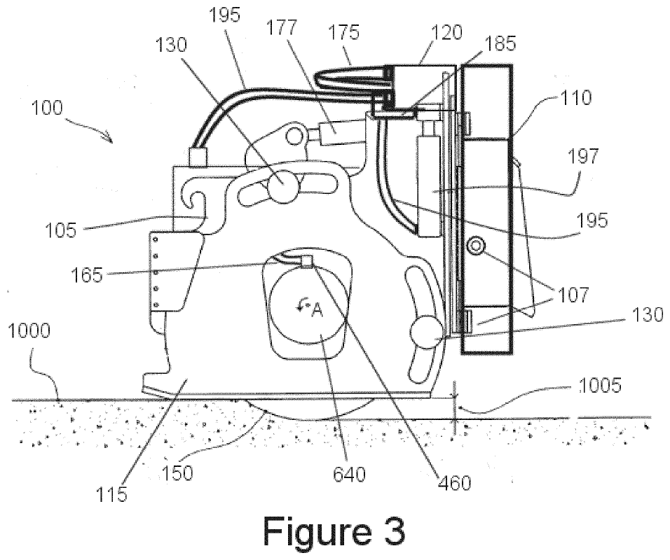

The main mounting frame 110 is provided with the attachment connected thereto by attachment connectors or skid steer coupling(s) 107, for instance in the case of a BOBCAT skid steer the BOB-TACH ISO 24410 frame and coupling are one non-limiting example of a quick coupling interface between the attachment 100 and the skid steer 10 as is known in the industry. A planing or milling drum or roller 150 is mounted within attachment frame 105. The planing drum 150 spinning on an axis A as shown in the figure, rotates grinding elements 155 (best seen in FIG. 2) thereon. Sliding mount points 130 are provided within the skid plates 115. These slots 130 allow for depth adjustment which is at the same time independent of the level of the skid steer 10 relative to the attachment 100; this feature allows the planer to also be “self-leveling”. The depth is controlled by cylinder 177 and it connects the attachment frame 105 to the skid plate 115. Hydraulic cylinder 177 is coupled to the auxiliary hydraulic line 175, as best seen in FIGS. 3 and 4A-4B, controlling position of skid plate 115 and are provided on either side of the roller or drum 150 and attachment frame 105. The planer slides along the ground 1000 on the skid plates and cutting depth 1005 is defined by the distance from the bottom of the skid plates 115, 117 to the tangent of the grinding elements 155. In some instances the depth of the left and right skids can be independently controlled, in which case hydraulic cylinder 197 is controlled by hydraulic line 195 to adjust the left skid 115 relative to the attachment frame 105. A similar cylinder and line are provided for adjusting the right skid 117 with hydraulic line 195 connecting to cylinder 197. In additional instances, the attachment frame 105 can be shifted left to right with hydraulic cylinder 187 controlled by hydraulic line 185.

The operator manipulates lift arms 50 and planer attachment 100 by selectively actuating the hydraulic systems. This can include, but by no means is it limited to, lifting the arms 50 and thereby the attachment 100 as well as specific controls of one or more movements within the attachment, in this instance as best described herein below with respect to FIG. 3 which shows a close up of the planar attachment 100 of the exemplary embodiment but generally including roll, depth of cut/vertical traverse, horizontal traverse, and drum rotation speed. Again, the operations in this exemplary embodiment are described herein below in greater detail and specifically for the exemplary embodiment shown. Similarly, additional attachments like those listed above and herein, can utilize similar and/or additional hydraulic controls, including those similar to the general planer or can include hydraulic control inputs for specific operation of these additional attachments without departing from the spirit of the invention. In all instances, sensors 460 are provided to monitor the work done by the attachment through sensed parameters, including but not limited to pressure, in such systems.

As noted a wide number of further attachments can include but are certainly not limited to lawn mowers, tractors, tiller, excavators, self-propelled saws, tracked loaders, wheeled loaders, dozers, and similar devices, attachments with bundlers, landscape rakes, mulchers, stone crushers, sifting devices, planers, beach cleaners, soil conditioners, snow blowers, stump grinders, flail mowers, rotary mowers, wheel saws, asphalt saw cutters, trenchers, planers and the like as attachments to a vehicle or device as noted previously. The vehicle or carrier 10 can use the frame or frame interface 107, which can for instance be an ISO 24410 107 standard interface, to quickly change the attachment 100.

There can be variations in the attachment pertaining to the number, size, and similar aspects of the hydraulic motor(s) 640, as introduced in FIG. 2, which perform the processing work in the attachment 100. These variations can include, for instance but are not limited to, the nature of the displacement (e.g. variable or static), motor gear ratios, vane number and orientation, and the like as non-limiting examples of variations affecting the variables and work done. For this reason, the operator has the ability to adjust parameter settings within the controller 500. These can be changed to accommodate the various configurations and changes in the nature and types of attachments. This adjustment can be done manually or automatically through controller software stored on the controller 500 or accessed by controller 500 with recognition of the attachment being done automatically or manually or by some combination therein.

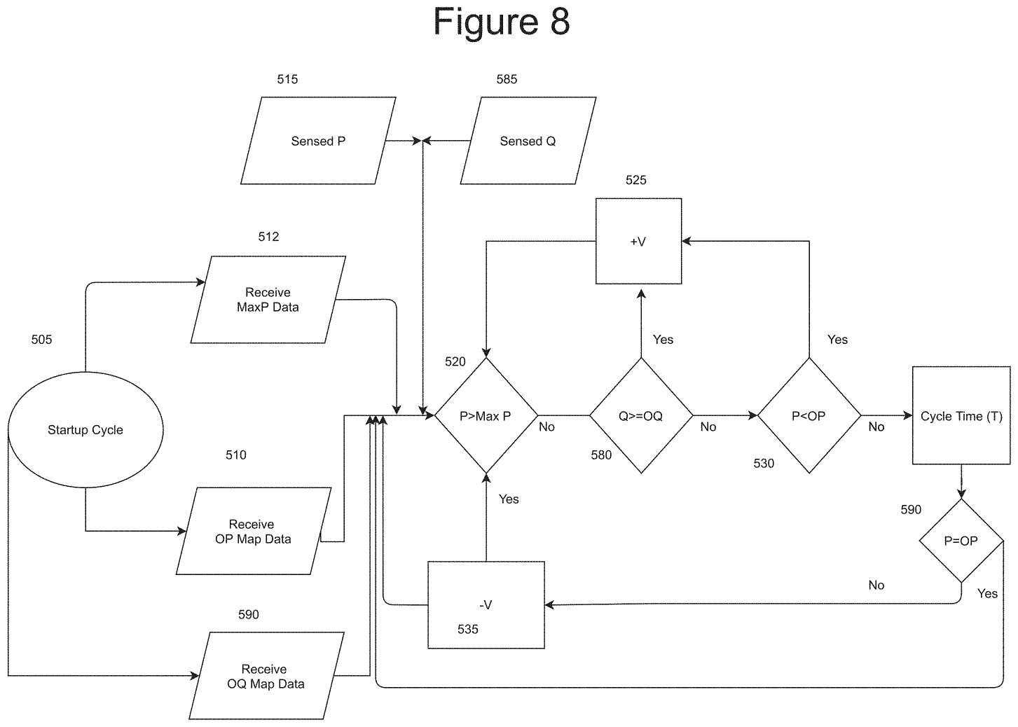

Additionally, variations in the desired noise profile or operation speed of the main motor 660 output during operations (100% vs 75% for throttle for instance) can vary power available to the attachment 100 as discussed herein. With less power available, less work can be performed. The controller 500 can sense and adjust accordingly. This can be done either manually or automatically through the controller 500. For example, if noise regulations require operation of the machinery at lower decibel levels, the engine is typically run at a lower throttle setting. The controller 500 can be programmed or set to accommodate this requirement. Similarly, in instances where flow measurements are included in the controls, such as that shown in FIG. 8 herein, the flow is most directly affected by the throttle setting and similarly any changes in the setting will need to be accounted for by controller 500.

These further implementations would necessarily be adjusted such that the inputs from and to the hydraulics controlling the given attachments 100 are applicable for or to that type of attachment 100. With the instant invention being adjusted to provide control and monitoring of the hydraulics as specified herein on the controller for the particular attachment as would be understood by one of ordinary skill in the art such that an at least one parameter, such as but not limited to pressure, flow, and pressure and flow, which is measured to determine instantaneous work done by the attachment and monitored such that the work at the attachment based on an at least one parameter that is monitored and kept within an optimized work range based on adjustment of the at least one parameter and/or an at least one input principally effecting desired changes in the at least one parameter.

FIG. 2 shows a further front view showing the exemplary embodiment of FIG. 1. The attachment 100, again in a non-limiting example depicted as a planar, has a main attachment frame 105 coupled to the lift arms 50 by frame connectors 107. The frame and connectors can be but are certainly not limited to being a universal connector, for example and certainly not limited to those referred to in the industry as a BOB-TACH or an equivalent ISO 24410 connection interface. As depicted in FIGS. 4A and 4B, the attachment 100 is further provided with a hydraulic manifold 120. The manifold 120 is supplied through hydraulic line(s) 90 from the vehicle 10. The hydraulic manifold 120 has supply line outputs 165, 175, 185, 195 with sensors 460 coupled to the hydraulic lines and electronically communicating with the controller 500. The manifold 120 and lines 165-195 are better shown in FIGS. 4A and 4B. The attachment hydraulic lines 175, 185, 195 are in turn coupled to and supply power to and actuate the respective hydraulic cylinders 177, 187, 197 and, in certain representations shown in FIGS. 4A and 4B, as well to hydraulic lines 165 and hydraulic motor 640.

As described in greater detail in FIGS. 3, 4A and 4B below, the hydraulic lines also include an attachment drive hydraulic line 165 that powers the hydraulic motor 640 which turns the drum 150, as well as cylinders and lines that provide left depth controls through and right depth controls 195, 197 and left/right translation 185, 187 respectively within the frame by actuating the respective hydraulic systems.

In use, as shown in FIG. 2, the two opposite slides 115 and 117 are brought into contact with the upper surface 1000 of a surface layer 1000 to be processed and/or milled. The surface layer 1000 can be for example, but is certainly not limited to being, a solid layer on which one can walk or drive, for example made of asphalt, cement or similar materials. The processing depth 1005 is set by adjusting the position of the slides 115 and 117 with respect to the main frame 110 such that the drum 150 is extended down to a depth of cut 1005 as guides 115 and 117 rise and reach the set depth. The operator can adjust roll, horizontal position, and depth of cut, as discussed, with controls in the cab 40. Further, the speed of the drum as well as the speed of the vehicle 10 can be adjusted.

In the exemplary embodiment, as a non-limiting example the depth of cut, roll, lateral position, initial operating speed of the drum and similar variables are set by the operator or selected from a pre-programmed profile or a combination of both. There are a number of processing parameters affecting the loading. The loading of the drum is directly proportional to the work efficiency of the tool, thus the optimal speed of the drum should be maintained in the exemplary embodiment of the instant invention shown with a planar attachment to maintain optimum loading and not a variable in this exemplary embodiment. However, for the exemplary embodiment affecting the work of the attachment 100, the advancement velocity of the operating industrial vehicle 10 which is governed by the operator O, for example, by means of a maneuver joystick or other inputs as discussed herein, directly affects the feed rate and thereby the loading of the invention. The loading is directly proportional to the measured pressure of the hydraulic line for the motor and thereby the work performed. The instant invention when engaged adjusts automatically based on sensed parameters the velocity of the vehicle and thereby feed rate of material and thereby the work done based on sensed parameters so as to maintain the loading through monitoring pressure and maintaining the ideal work output at the attachment. The vehicle being slowed or sped up to maintain the load on the milling drum and work efficiency at the drum at an optimum level.

In alternative exemplary embodiments, the attachment can be affected by more than one variable in optimizing the work output. Basically, the source of power in the system, industrial vehicle or industrial device can be adjusted by throttling that source up or down. In the principal exemplary embodiment shown this is through the main drive motor of the vehicle. In alternate exemplary embodiments this can be the drive motor for the attachment. The throttling up or down will adjust, in the example of a hydraulic system, the flow of hydraulic fluid. The pressure and flow together are used to calculate power. This power over time is equivalent to work output. For the exemplary embodiment of the planer shown, ideally the planar attachment should be operating in the upper range of the pressure to ensure that the attachment is being “loaded up” and not just freewheeling, e.g. spinning without sufficient feed of material. Too high of a pressure is indicative of a stalled attachment and all the hydraulic fluid will leak out through the pressure relief valve, so the operator wants to stay in this optimum operational range or the “sweet spot” balancing feed rate or forward velocity with pressure at the working element of the attachment.

Thus the exemplary embodiment shown and further alternate exemplary embodiments can also adjust for flow rates within the system. The flow rate can be adjusted in a further exemplary embodiment of the planar shown so as to accommodate, for instance, cutting through differentiated materials, e.g. asphalt to concrete, flow can be continually optimized. This follows as in principal the drive motor or attachment motor should be sized so that it's operating at an optimum RPM at some predefined power or throttle setting, e.g. on a maximized power curve. And flow rate optimization for a planer controls the speed or velocity of the rotating drum and optimizes it in conjunction with pressure. For instance, in cutting concrete optimized performance would generally be had at slower rotations while with looser, less dense material like asphalt higher rotations would be optimum. This could be sensed by changes in the pressure in the system and the flow sensed and regulated in conjunction with the detected pressure.

Whereas, for alternative exemplary embodiments, something like a flail mower attachment, the RPM of the blade is more critical than pressure in the performance of the attachment. The RPM of the cutting edges of the flails cannot drop below a certain RPM otherwise you will not cut the grass, you'll bend it. Thus in this instance a minimum rotational velocity for proper operation must be maintained. Since it is known that the flow can vary with power available as well as differences in the attachment (e.g. different motors), it becomes more complex tracking the loading and maintaining flow in these instances for an operator, but can be optimized using the instant invention.

In either case though, having a high rotational speed of the working motor can mean that the system is freewheeling and not loading attachment motor enough, either through some minimum rotational speed (mower) or some maximum load/pressure (planer). The instant invention is unique in that it is automatically monitoring and adjusting for these variables to optimize work output at the attachment. Similarly, it is flexible and adjustable enough to provide for the “smart” controller inputs and outputs needed to overcome issues with needing an experienced operator by assisting inexperienced operators in managing the complex operating variables whilst adapting to the variety of potential attachments and the types of inputs and output necessary to accommodate different applications.

FIG. 3 is a side view of the planer attachment attached to the embodiment of FIG. 1. The attachment 100 is generally known as a planar and comprises a main mounting frame 110 to which a processing and/or planing drum 150 is rotatably fixed. A body or attachment frame 105 is provided that supports the roller or planing drum 150. The frame mounts a hydraulic manifold 120, from which auxiliary hydraulic outputs 165-195 extend as discussed herein. Hydraulic cylinders 177, 197 are coupled to hydraulic lines 175, 195 to respectively move the left skid 115 and right skid 117 up and down, thereby controlling the depth of cut 1005 into surface 1000. The mounting frame 110 further comprises connecting and/or fixing means 107. These connect and/or fix the attachment 100 to the vehicle 10. The attachment 100 can be detachably or non-detachably fixed to the main operating machine 10 driven by the operator O.

Milling or planing elements or tools 155 extend from the outer surface of the processing, milling, and/or planing drum 150, as best seen in FIG. 2. The milling drum 150 is in particular rotatable about a main rotational axis indicated as A. This axis runs substantially coincident with the symmetrical axis of the milling roller 150. Furthermore, the milling tools 155 can be, depending on the needs and/or circumstances, fixed or interchangeable.

In this instance, in the exemplary embodiment featuring the planar attachment 100, the auxiliary hydraulic motor supply line 165 is coupled to and supplies power for the planer drum 150. A sensor 460 is supplied and located as part of the coupling of the auxiliary hydraulic supply line 165 to the attachment hydraulic motor 640 for the drum 150. The sensor can be, for instance, but is certainly not limited to a pressure transducer or pressure and flow transducer or a flow meter or the like. Although a single sensor is shown, additional sensors to confirm pressure and/or flow changes and monitor the pressure elsewhere in the system can be provided. Similarly, additional types of sensors and additional parameter measurements, for instance flow and pressure or only flow, can also be measured and utilized in the operation of the vehicle.

In particular, the industrial vehicle or device 10 can be of the type shown in FIG. 1, i.e. of the type wherein the attachment 100 is detachably fixed to the front part of the main operating machine 10, such as to the loader arms 50, or of the type wherein the apparatus is fixed to a fully articulated connecting main arm or extension, such as a backhoe or similar vehicle, which enables actuating and moving the same apparatus and, in particular, positioning it in the desired operating position in similar fashion. The principles of operation of the tool to maximize efficiency as embodied in the instant invention apply regardless as the parameters remain similar. The feed rate or forward velocity applied to the tool can be monitored and managed to maintain an optimal efficiency for the tool. Similarly, the specific nature of the tool may change but the concept of the controller and control systems maintaining efficient operation are similar.

In an alternate embodiment within a tool carrier or vehicle which has a flail mower the attachment motor and other elements related to for example hydraulic controls including but not limited to the manifold and the related hydraulic lines would be similar. The flail mower attachment, as described herein, is a similar drum shape having pivoting blade or flail elements attached along the circumference of the drum. The blade attachments spinning with the drum or rotating with the drum provide a cutting motion above a turf surface such that the grass is struck by and cut by the blade attachments. For this alternate exemplary embodiment, the rotational speed of the drum is monitored by an at least one sensor which can monitor flow or pressure or pressure and flow. The controller is also similar to that of the exemplary embodiment shown for the planer, but it can also include the monitoring of the RPM of the attachment and/or the flow being sent to the attachment which is directly proportional to the RPM.

Turning back to the exemplary embodiment of FIGS. 1-3 again, the attachment 100 further comprises at least one sensor 460 in communication with the controller 500. Though, again, a single sensor is shown, additional sensors are contemplated in further exemplary embodiments to report pressure, flow, and additional parameters to the controller. These sensors can include pressure transducers, flow meters, and the like. Other indirect means of measuring flow or sensing pressure via optical rotation sensors, vibration sensors, interval timed switches or closed pressure tubes can also be used, but as noted these can have issues in the operating environment which would need to be addressed. The sensor(s) 460 are located in such a position with respect to the attachment 100 so as to provide accurate instantaneous readings of measured hydraulic pressure(s) in at least one of the auxiliary line(s) 165 driving the attachment 100 such that it can report this value to the controller 500 and the controller can relate this pressure to overall work being done by the attachment 100 in the exemplary embodiment.

The velocity of the vehicle 10 governs feed rate as noted above and is typically the principal adjustment being made to achieve the most efficient work from the vehicle and attachment in the basic exemplary embodiment. In prior art machines, this is governed by an input made by the operator O in the cab 40 on the fly as discussed above in the background of the invention, this is often done based on “feel” or operator experience. It may be supplemented by the readout from a pressure gauge such as that marketed as the PERFORMER. However, only the exemplary embodiment of the instant invention utilizes a stored mapped performance curve or surface based on pressure, flow, or pressure and flow or similar variables to set an optimal efficiency target for the work being done at the attachment 100 and determines with the sensor(s) 460 where the current operation is relative to that curve and then assists in adjusting or adjusts the vehicle speed.

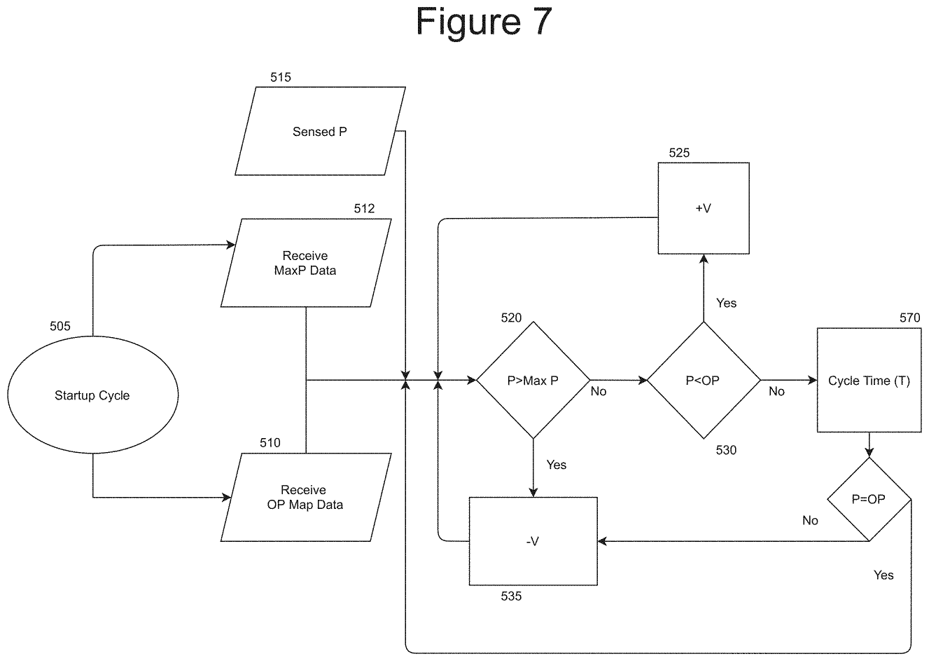

In the exemplary embodiment of the industrial vehicle shown, the measured instantaneous work as sensed by the sensor(s) 460 and the resulting changes in the variables are then processed by the controller 500 as described herein below. The velocity of the industrial vehicle 10 can be adjusted to adjust feed rate by the controller 500 and maintain a determined maximum efficiency of operating the attachment 100, an exemplary embodiment of this process being described herein below in reference to FIGS. 7 and 8. The initial inputs for the controller 500, whether set by operator or obtained by the controller 500 when the instant invention is activated, can be adjusted automatically by the controller 500 and maximum work efficiency maintained at the attachment 100. This would reduce the need for an experienced operator to adjust and maintain performance by touch or feel.

FIG. 4A shows a front view of an exemplary embodiment of a manifold for the attachment of FIG. 1. The manifold 120 is shown with four auxiliary outputs 165, 175, 185, 195 and a main hydraulic input 90 and main hydraulic return 99 from the manifold 120 are shown. Each output is coupled to a hydraulic motor, hydraulic system, or hydraulic cylinder 640, 177, 187, 197. Additional ports 196, 186, 176, 166 for the return of hydraulic fluid are shown on the valve block or manifold 120. These ports allow for two way functionality of cylinders (pressure/return) in the hydraulic system as would be understood by one experienced in the art. As noted above, the inputs and outputs can be but are certainly not limited to being connected by quick connect type connectors to the manifold 120. The lines can be standard hydraulic rated lines which are under pressure during operation of the industrial vehicle 10. The sensor 460 can be seen along the hydraulic supply line 165 which supplies pressurized fluid to the tool or attachment motor 640. A pressure relief valve 682 is shown connected to pressurized line, in the exemplary case hydraulic supply line 90, but this can also be another hydraulic line such as 165 or the control valve 120 as shown in FIG. 4B. The pressure relief valve 682 then dumps excess pressure into drain line 683. If the system pressure exceeds the crack pressure as noted below, the pressure relief valve 682 opens and allows fluid to flow out the drain line 683 and reduce pressure. The manifold 120 shown is for the exemplary embodiment of the planar attachment 100. Alternate embodiments can omit the manifold in favor of direct hydraulic lines from the vehicle or additional lines can be added to a manifold in additional auxiliary embodiments. Additionally, the location and number of pressure relief valves in the system can vary none-the-less the functionality of the valve(s) remains the same. Further embodiments representing additional attachments will similarly adjust the manner in which hydraulic pressure is provided to the particular attachments without departing from the spirit of the invention.

FIG. 4B shows a front view of an alternate exemplary embodiment of a manifold for the attachment of FIG. 1. The manifold 120 shown in FIG. 4B is another typical manifold known in this field. It provides direct pressurized hydraulic fluid from the motor through line 90 and the at least one sensor 460 and then feeds pressurized hydraulic fluid through an output line 164 to the principal input 154 for the manifold 120. The manifold maintains output ports 195, 185, 175 and return ports 196, 186, 176 together with the main return line 99. Relief valve 682 is provided and governs pressure. If pressure in the valve block 120 exceeds the crack pressure of the relief valve 682 the drain line permits outflow of the fluid to reduce pressure. It is further contemplated that several other connections to the drain line or multiple drain lines can be provided to allow for drainage of leaks and the like and, in some instances, designs can incorporated additional check valves in the system and subsystems to protect the vehicle and/or attachment without departing from the invention.

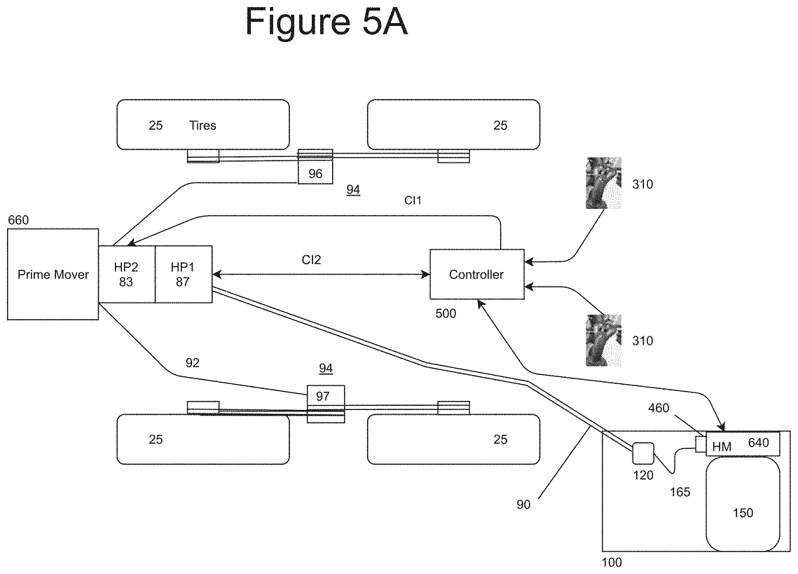

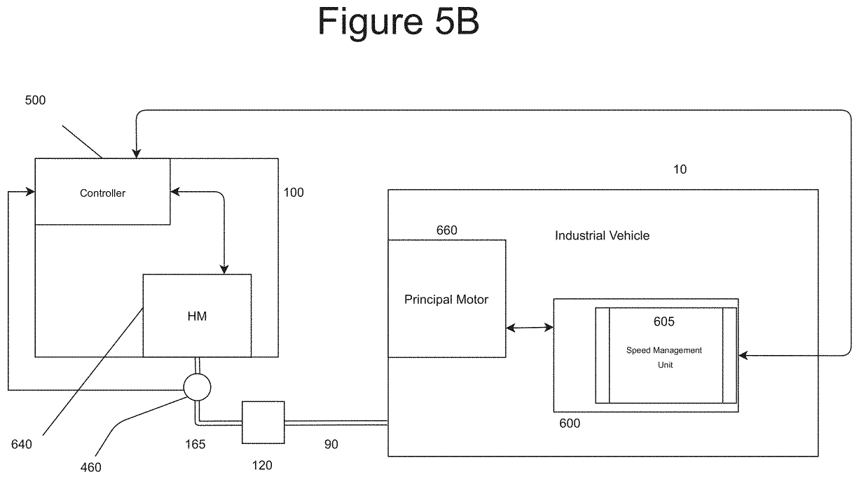

FIG. 5A is a plan view of the exemplary embodiment of FIG. 1. FIG. 5A showing the hydraulics, vehicle control, sensor, and other sub-systems of the exemplary embodiment of FIG. 1. The skid steer 10 has at least one prime mover or drive motor or principal engine 660. The principal engine 660 is shown in an engine compartment 30 depicted on FIG. 1 on the skid steer 10 of the non-limiting, exemplary embodiment of the instant invention. The principal engine 660 is typically, but not necessarily, a diesel engine. The principal engine 660 is coupled to and powers a drive train 94 which transmits power to the wheels 25. The prime motor 660 powers at least one hydraulic pump, herein shown as hydraulic pumps 83, 87. Though reference is made to two such pump systems, in all instances, a single pump or motor system or multiple pump or motor systems exceeding those described are contemplated and can be used without departing from the principals of the invention. Reference is herein made to an exemplary embodiment having these principals systems for brevity and clarity.

Further systems can be incorporated to provide power, transmit power, or couple to the controller of the attachment 100 or of the industrial vehicle 10 without departing from the instant invention. Additionally in this description of an exemplary embodiment, reference is also made to a single motor in the attachment throughout the description for brevity. Though single motor attachments are shown in the exemplary embodiment, multiple motors can similarly be provided without departing from the spirit of the invention and can be equally used in the control logic/schema of the instant invention. Though these pumps and motors reference hydraulic systems, the systems can provide either electric or hydraulic power through supply lines to similar effect. In fact, as noted herein, electric power systems can be operated in an analog to hydraulic systems and the current measured as part of a single or more measurement within the system similar to hydraulic pressure being measured in the hydraulic system to determine work. Additional measurements can be but are not limited to frequency, voltage or current, and can also include parameters described within exemplary embodiment.

In the exemplary embodiment shown, these pumps 83, 87 supply hydraulic power through pressurized hydraulic lines, 91, 92 to an at least one hydraulic motor, here depicted as two motors 96, 97. The motors 96, 97 as part of the transmission each powers the transmission 94 and drives wheels 25. The power rating of this principal engine 660 establishes the power budget of the vehicle, machine or industrial device in the case of a non-vehicle implementation of the instant invention and is shared by the drive elements as well as the working elements in the attachment.

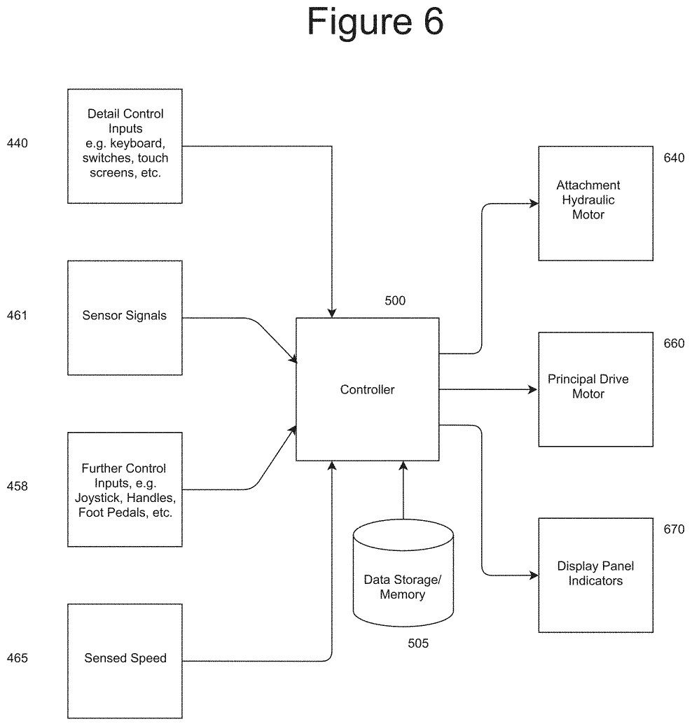

On hydraulic machines like that shown in the exemplary embodiment, the power that the principal engine 660 can produce has to be balanced with the power that the at least one hydraulic system(s) use or uses. The maximum amount of power that the principal engine 660 can make depends on the power or throttle setting at which it is running. On the skid steer loader or a similar industrial vehicle 10, the principal engine 660 can be operated at full speed and can produce its top rated horsepower, but this is typically shared at least between its drive function or vehicle velocity and the work being done by an attachment 100. There is a budget of power that has to be distributed between all the functions, but, if the velocity demand and attachment work demand are too high, the prime mover engine 660 stalls before crack pressures are reached or the maximum pressure or flow which is available for the attachment is inadequate for any useful function. These limits and their use in the control and operation of the instant invention are detailed further herein in relation to the controller 500, as shown in FIG. 6 and described herein, and the operation disclosed in the flowcharts of FIGS. 7 and 8.

The power used by the hydraulic motors or pumps is equal to its pressure multiplied by the flow rate of its fluid. The faster the given motor or pump spins, typically, the higher the flow rate. As a load is applied to the motor, the pressure increases, and the flow decreases. This tradeoff between flow and pressure continues until the crack pressure of a pressure relief valve of the hydraulic circuit is reached. When this pressure is reached and the relief valve opens, the pressure drops down again, and the valve stays open until it reaches a lower pressure. This curve is the power curve which is allotted to the hydraulic motor by the pump, the valve block on vehicle 10 or attachment 100 and engine system providing both maximum work efficiency pressure targets (OP as described below) as well as maximum pressure (Maxi as described further in relation to the flow charts in FIGS. 7 and 8.

The system is designed so the full power of the principal engine 660 can be provided to the wheels or tracks 25, lift arms 50, and the implements or attachments 100 at any given time or, that this maximum power is split between the drive, work group and attachment systems as needed. In most instances in vehicles and industrial devices like the skid steer 10 shown, it is up to the operator to carefully modulate the controls to keep the tool motor 640 from stalling by exceeding the available power, which requires skill and practice. To operate the attachment 100 efficiently, e.g. maximize efficiency, speed and processing work done at the tool or attachment 100, again, this is part of the balancing done by an experienced operator in existing devices. This requires the operator to understand and adjust for a multitude of variables for optimization, including vehicle speed and attachment or tool operational speed. At the most basic level the feed rate of operational material to the attachment primarily effects the production and power demand and dictates this balancing or tuning.

There exists an optimum efficiency along this pump power curve which in some embodiments can be used, but in other embodiments, only the performance of the hydraulic attachment or tool motor in completing its instantaneous task is taken into consideration to establish an optimal range. This task efficiency can typically be achieved by maintaining, for example but certainly not limited to, an optimum rotation speed as defined by flow or by optimum resistance or load as defined by pressure or a combination of each measurement as sensed by the at least one sensor 460. In the exemplary embodiment of FIG. 5A the velocity of the loader 10 affects the load applied to the tool or attachment motor 640 working in the attachment, which then impacts the flow and pressure. In this example, with an understanding of where this optimum flow and pressure point or range of points are as stored on the controller 500 for the tool or attachment motor 640 and/or pump, efficiencies can increase and reliance on experienced operators “touch and feel” is reduced by the controller 500.

The instant invention assists in addressing this need by providing controller 500 that can modulate the prime mover or drive motor or main motor 660 power demand and the attachment power demand, essentially optimizing the performance automatically by sensing the output of each and performing the adjustments automatically to outputs that adjust the resulting work. This is accomplished by careful control and monitoring of the power at the attachment 100 and its hydraulic motor 640 by the controller 500 so that it is engaged in maximum work output whilst simultaneously modulating the power to the prime mover or drive motor 660 to move the equipment and feed the attachment, balancing feed rate and work done by the attachment automatically. The steps of this are explained in greater detail with reference to a flow chart in FIGS. 7 and 8 below, however, sampling is done by sensors 460 detecting the pressure or flow or pressure and flow in the attachment motor or the attachment sensors and similar sensors can monitor sensors can monitor other hydraulic systems, including but not limited to the drive motors 96, 97 and prime mover or motor or principal engine 660 system. The controller 500 uses the programmed logic to maintain the balance between the at least one auxiliary hydraulic system and balance the forward motion of the industrial device or vehicle and thereby the feed rate of the working surface to the attachment or tool 100. This balances the effective work done to maintain maximum efficiency and avoid “stall” of the attachment.

As noted, in a non-limiting example of a further alternate exemplary embodiment of an attachment within an industrial vehicle or machine a flail mower attachment can be provided. This type of attachment has a flow rate that would be more paramount to define optimal work performance more than pressure alone, vis-a-viz forward velocity, to maintain feed rate as the input to adjust and optimize work output. A flail mower is a type of mower which has a horizontally oriented drum which is powered by a hydraulic motor. The drum has cutting implements, typically but certainly not limited to blade elements shaped like and referred to as hammers or small blades mounted on hinges along the circumference of the drum. The centrifugal force of the rotating drum keeps the cutting implements extended until they make contact with grass, branches, saplings, or the like upon which the attachment is being applied. Upon contact with the grass the cutting implement either cuts through the material or hacks at it, and folds back at the hinge, thereby minimizing the energy loss of the cutting implement getting hung up on something.

In this application, maintaining an optimal rotational speed or angular velocity is important in defining feed-rate. If the rotational speed of the drum is too slow, the blades will fold back and not cut the material or the material may just fold back and not be cut. If the drum is spinning too fast, it could damage the drum due to excess force, but more importantly as noted in planer application, a fast spinning drum is still a sign of ‘freewheeling’ and is not efficient. In this application the flow rate must be kept within a range which matches the material being processed by adjusting the feed rate or forward velocity of the tool carrier. Similarly, in other embodiments of the exemplary embodiment of the planer, it can be beneficial but would increase complexity and cost for the operator to operate within a flow rate range due to a need to process various materials at different cutting speeds, e.g. a surface that is non-uniform in structure or material type. Similar to machining metals, harder materials like concrete should be processed at lower rotational speeds while softer materials like asphalt should be processed at higher rotational speeds. In this instance, like with the flail mower attachment monitoring both pressure and flow in the analysis of work done at or by the attachment is specifically contemplated.

Complicating the matter in implementing flow and pressure controls in these alternate exemplary embodiments is that fact that as the vehicle starts to move faster, the blade speed needs to remain high enough to cut as the limited power provided by the prime mover begins to be diverted toward propelling the vehicle forward at higher speeds. The total power supplied remains constrained by the prime mover and the maximum pressure will be the same, as defined by relief valve and crack pressure but the available flow will decrease with increasing speed in an appropriately designed hydraulic system. Similarly in the non-limiting example this alternate mower exemplary embodiment, the at least one sensor in conjunction with the controller will be monitoring the rotational speed of the flail component of the mower while at the same time adjusting pressure to govern feed-rate or forward movement, the controller will need to ensure that the power available to the mower attachment does not fall below a threshold as power is diverted toward the forward drive, e.g. maximum forward speed is reduced to maintain the flail speed.

FIG. 5B shows a plan view of the controller of the instant invention in an exemplary embodiment mounted within an attachment and communicating with an existing vehicle speed management unit (SMU). Sensors 460, as noted above, measure the flow, pressure, or flow and pressure or like parameters being developed at the working attachment motor 640 in the supply line(s) 165 as discussed. In the case of the exemplary embodiment of FIG. 5A, the controller 500 is mounted on or within the vehicle and incorporated as a component of the vehicle control system. In contrast the exemplary embodiment of FIG. 5B the controller 500 is mounted in the attachment as part of the attachment and communicates with a vehicle controller 600 having an SMU 605. This can be produced as an attachment or as a kit for an attachment incorporating the instant invention. The SMU 605 on the vehicle 10 in turn communicates with and controls the velocity of the vehicle 10 as previously described.

In this exemplary embodiment, the separate controller 500 is shown on the attachment 100 and communicates with the at least one sensor(s) 460 coupled on the attachment hydraulic motor 640. As shown FIG. 4A, an auxiliary hydraulic system line 90 feeds a manifold 120 with an at least one hydraulic motor line 165 coupled to the auxiliary hydraulic motor 640 through the at least one sensor 460. A hydraulic return line 166 is shown exiting the hydraulic motor 640 returning fluid to the manifold 120 and a further auxiliary hydraulic return line 99 is shown returning fluid to the vehicle 10 and a fluid reservoir (not shown). As mentioned previously, the hydraulic line 165 can be coupled to the vehicle 10, the manifold 120, the sensor 460, any of the hydraulic lines and/or the motor 640 with quick attach couplings or the like.

The controller 500 is mounted separately on the attachment 100, communicates with the at least one sensor(s) 460, the attachment hydraulic motor 640, and the industrial vehicle 10. As part of the communications, the at least one sensor(s) 460 measures at least one parameter as discussed at length herein. These measurements and the communications are transmitted, wirelessly or by wire to the controller 500 as inputs. The controller 500 can be, as pictured here, a single dedicated controller that is located on the attachment 100 and communicates, again by wire or wirelessly, with a master controller 600 on the industrial vehicle 10. The industrial vehicle 10 has a separate speed management unit (SMU) 605, as noted herein above, as a component of its systems controls which is typical of most construction vehicles. The SMU 605 communicates with the main drive unit 94 which has additional components, e.g. servos, manifold, and can adjust forward velocity as part of its typical function. In this exemplary embodiment of the controller of the instant invention, the SMU 605 also communicates with the attachment controller 500.

The controller 500, sensing and communicating the pressure transmitted by the at least one sensor 460, can mimic the existing inputs for “faster” or “slower” commands available on loader 10 that are typically communicated to the SMU 605 by the operator O through control inputs 310. In this way, the exemplary embodiment can replicate existing control inputs available through the manual control inputs 310 in the cab 40, as further described herein in relation to the flow charts of FIGS. 7 and 8 below, requiring minimal modification to the existing controls and inputs in vehicle 10. In this fashion, this configuration provides for the attachment logic discussed herein below to be retroactively applied to existing loaders and similar industrial or construction vehicles as part of the attachment 100.

FIG. 6 shows a plan view of the controller of the instant invention in an exemplary embodiment. On the left, control panels inputs and the like are provided at 440. These inputs represent control panels, switches, interactive screens similar to those in existing skid steers that provide commands, queries and similar input to the controller. A set of sensor(s) signals or inputs 461 are provided from the at least one pressure sensor 460 and also represent similar sensor(s) data in the skid steer to detect various operating conditions. A further set of control inputs are provided at 458, these can represent for example, but are not limited to, joystick controls like those shown above as 310, foot pedals, hand controls and similar control elements. Finally, a vehicle speed sensor control input 465 is also provided to communicate the status and nature of the vehicles velocity or speed. This can be a single input as in the exemplary embodiment representing forward velocity or additional data points representing various aspects of the velocity, e.g. direction, acceleration, etc.

Additional inputs can be included without departing from the invention, these can include for instance but are certainly not limited to side drift caused by sloping road or non-centric resistance from the attachment or other interface variables and the like. For example, if the planer has a horizontal offset to the right, the loader will tend to drift to the right since there is more resistance on that side due to the offset. There is a program setting within the vehicle controller 600 which allows the system to accommodate the offset or drift so it does not have to be managed manually. The controller can also store information, for example if an operator or vehicle is operating at less than optimum performance or speed this can be stored and/or an ability can be provided to track productivity and efficiency and store it or provide real time measurements and tying this to instances where maintenance can be required or indicated as being needed— e.g. monitoring when it is time to get new teeth on the drum.

The controller 500 is in communication with controller data storage 505. This can be for instance memory to store data on the controller 500. It can also be a wireless link to an off board/controller storage in a cloud network or a detachable or programmable data storage device such as a hard drive or removable storage device, for example an SDSC card or thumb drive, with information stored thereon. As discussed below in relation to the flow chart for the software operating on the controller, the data stored can include specific optimized pressure and performance data used to determine whether the attachment 100 is operating at optimized performance. It can also contain software, firmware, or other operating code and programming to operate the attachment or vehicle. It can also function as storage for historical or operational data that is retained during and/or after operation. This data can be used for diagnostics or to improve the accuracy of the optimization values provided through machine learning (AI). It can also be used to adjust for wear and other factors affecting the attachments ability to do work. The controller 500 receives these data inputs as specified. It acts upon these data inputs utilizing the stored programming thereon, for instance using the method outlined in the flowcharts of FIG. 7 or 8 or an alternative embodiment of the operation.

The controller 500 in turn sends or transmits data outputs represented on the right side of the diagram. The data inputs and outputs shown are non-limiting examples, intended to illustrate operation in the exemplary embodiment described. Additional inputs and outputs are contemplated and can include, for example, but are not limited to engine RPM, oil temperature, cutting element velocity, attachment RPM, attachment temperature, attachment torque, vehicle and/or attachment drift velocity or vectors, attachment angle of attack, inclination of work surface being traversed, sensor data representing wear on the vehicle or attachment or both, manual inputs representing wear or condition of the equipment including but not limited to for example time in service, blade sharpness, time on job and the like. In the exemplary embodiment shown, the controller 500 communicates with the attachment hydraulic motor 640, the principal drive motor or engine or prime mover 660, and display panel indicators 670. The display panel indicators 670 can include, but are certainly not limited to, responses on a screen, indicator lights, and the like.

In the exemplary embodiments wherein the controller 500 is an attachment controller communicating with a speed control unit as in FIG. 5B above, the controller 500 communicates to the speed control unit 605 of the skid steer or industrial vehicle or machine 10 as part of the outputs. As described in further detail herein below in the flowcharts of FIGS. 7 and 8, this can include signals that increase or decrease vehicle velocity of the vehicle. In the exemplary embodiment for instance, this can occur, but it is certainly not limited to, if the controller 500 senses that the attachment or processing tool 100 is “freewheeling” which is a condition whereby the feed rate is too low and the planar drum velocity is not sufficiently under pressure. Similarly, the controller 500 decreases the velocity for example, but this would certainly not be limited to, if the controller 500 senses that processing tool “stalling”, e.g. the planar tool pressure shoots up toward the relief pressure limit, whereby the condition of the drum velocity is also decreasing. In each instance, the pressure sensor data would be outside of the efficient operating parameters for the given attachment 100 and the controller would adjust automatically, again as further detailed with respect to the non-limiting examples in the flow diagrams in FIGS. 7 and 8.

This can, in the non-limiting example, be for instance a planar or trencher with a defined rotational speed at defined power settings that on the one hand shows when the planar or trencher is “freewheeling” or not engaged sufficiently with the work piece. On the other end of the spectrum, again in the non-limiting case of a planar or trencher, a sudden spike in power or slowdown in wheel speed associated with “stalling out” or a condition in which the feed rate and therefore the working rate of the attachment is drastically reduced can represent a lower bound. If either of the bounds is approached within a response margin or boundary condition, the sensors can detect the power demand shift and adjust the vehicle speed through a signal sent from the controller 500 and then in some instances unto the speed control unit 605. Though other variables and measurements which can be used, for instance but are certainly not limited to rotational velocities or shaft rotations, or the like. The fidelity of using the variables via the exemplary embodiment using direct measurement sensors provides near instantaneous analysis on work being done as this is directly correlated to the pressure, flow, or pressure and flow in these systems. The objective of the control schema or logic of the controller 500, as more clearly shown in the flow charts of FIGS. 7 and 8, is to avoid the boundary conditions and continue to work within an optimized band of power demand and/or operating speed. In the exemplary embodiment of the planar attachment shown, this results in the automated controlling of feed or vehicle speed based on how much the processing attachment motor in the attachment is being worked as measured by one or more variables in a hydraulic or electric system having a circuit that includes the processing attachment motor.

In addition to the output bounds programmed as a basis for operating or optimizing the cutting/machining process the controller can utilize or modify the bounds with additional variables that can be included to adjust the end limits of the bounds. These can be pre-programmed in the controller 500 or provided by the user as a user programmed input. For example, some non-limiting examples of operator adjustable factors, inputs, or variables can include factors that allow the operator to adjust for tool life, a model designator, a displacement, material variables, working surface material or surface composition, material consistency or specific descriptors related to processing tools or attachment, outdoor temperature, hours in service, an at least one variable representing tool wear and the like.

Filtering is needed to avoid oscillations in control inputs and outputs and is well known in modern control theory where sampling and response rates can be measured in nanoseconds and even picoseconds. To attenuate a feedback loop or similar issue, a time delay feature or sample averaging can be utilized to smooth inputs or outputs before changing velocities in the exemplary embodiment of the instant invention. One non-limiting feedback schema in vehicle control inputs of the type utilized in the exemplary embodiment of the instant invention mounting a planar attachment provides that the usual oscillation frequency of ground engagement is around about ninety (90) to one hundred twenty (120) cycles per minute, more preferably around about one hundred and ten (110) cycles per minute. This would translate into a time delay of about one (1 S) second to two point two seconds (2.2 S), more preferably about one point eight seconds (1.8 S) or more between sampling-cycles or samples or branches and restarting the loop would be sufficient to attenuate oscillations in the signal caused by variations in the material and/or from operator induced oscillations or the like. Other means of controlling, filtering and/or dampening via software, electronics (e.g. Field Programmable Gate Array (FPGA) or variable sampling cycle elements and gates), proportional-integrated-differential controllers or mechanical elements (e.g. timing gears, electromechanical switching) or similar can be used to the same result, effectively dampening a recurring input so that it does not amplify out of control.

With this in mind the exemplary embodiments shown in the flow charts of FIGS. 7 and 8 below are limited to describing the operation of the exemplary method of moving the attachment from a “freewheeling” condition to engaged in work as fast as possible, and, similarly if a “stall” is detected then moving back to reset as soon as possible. Therefore the time delay used for filtering would apply in situations where near ideal sensed conditions exist and are being maintained. Modification of the variables is intended and easily accomplished by reprogramming the selected values in the exemplary software solution indicated on the controller.

Of further note, with respect to safety, it is typical for an industrial vehicle like the loader of the exemplary embodiment and construction vehicles in general to have a speed limit setting on or within the controller of the vehicle. These limit the top speed at the forward most position of the joystick or other control input as set in the speed manager within the controller. In the exemplary embodiments of the method shown, the control outputs, the changes in velocity, mimic existing control outputs regulated by the existing safety controls within the software. This is important for the exemplary embodiment that is an attachment, as shown in FIG. 5B, as it reduces the need to reprogram or provide additional control software by utilizing existing safety protocols in the SMU 605 of the vehicle.

The construction vehicles existing speed controls can override functions in the exemplary embodiments shown. The construction vehicles velocity safety controls would stand and the adjustments made by the controller 500 would be understood in the comparable manner that existing input from the joystick controller or manual input of the operator were being actuated. In this sense and in a similar fashion though the controller 500 is sending the velocity adjustments, the safety software regulates it the same as if the operator were increasing or decreasing the velocity. In further embodiments, like those shown in FIG. 5A, it is fully contemplated that the controller 500 can alternatively be programmed with its own safety features and protocols to similarly limit and prevent unsafe operating conditions.

It should be made clear that by the expression “maximum performance” or “optimized performance” or “optimized work” appearing throughout the application and provided herein, these are generally defined here as the performance corresponding to an optimum workload or load which the machine and/or the attachment can bear for the maximum volume of material that can be processed at a specific engine power setting, while taking into account variability in the material in the case of the planar. In other attachments, where flow and thereby tool velocity is included and dominant in determining performance, the maximum performance would be an idealized range or point measurement of the flow or a combination of flow and pressure corresponding to an optimum workload which the machine and/or the attachment can bear.

Turning to the exemplary embodiment shown, it should be pointed out that in the exemplary embodiment of the apparatus for milling solid surfaces of known type, the hydraulic system is provided with a safety device comprising, for instance but certainly not limited to, a safety valve 682, which stops or blocks the roller and, if necessary, halts the entire machine by preventing it from advancing when the pressure within the hydraulic circuit reaches an absolute maximum threshold pressure (AbsP) set by the producer or operator. This absolute maximum pressure (AbsP) sets a targeted maximum pressure, herein referred to as maximum pressure (MaxP) a safe amount or delta under the AbsP. If the system is configured correctly, when the pressure in the attachment hydraulic line reaches the relief or crack pressure the valve opens and begins to dump excess pressure. The MaxP is set just below this pressure, just at the range the relief valve would begin to relieve pressure, a safe delta below AbsP.

If AbsP is reached and the relief valve engaged to dump pressure, this is generally referred to as a “stall” condition for the attachment. If stall is detected, the system reduces or halts forward movement and resets or allows the system to clear and come back below the absolute maximum pressure. Of note with respect to the prior art, if the loader is operating close to the crack pressure, the valve may begin to flutter which will cause a cyclic buildup of stresses and eventually premature failure of the pressure relief valve. The instant invention aids in avoiding such a wear on the pressure relief valve. Additionally, as noted with the prior art, the operation of the loader by an inexperienced operator can require additional time and effort if the operator is overzealous and causes stalling in the attachment frequently, increasing the operating time, job time, and general wear and tear on the vehicle as well as impacting the quality of the work done.

The instant invention avoids this by automatically maintaining the pressure at or below this crack pressure at a selected value MaxP. Ideally, MaxP is at a safe margin from the crack pressure and not exceeding it such that the relief valve does not open during operations. Thus MaxP can be set such that it is as high a pressure as possible without activating the relief valve and thereby functions at high working efficiencies but not in excess of the crack pressure and certainly well below the absolute maximum pressure which would result in stall and require reset.

Similarly, given an advancement rate or velocity, a rotational speed, and a depth of cut or thickness of material, an idealized work function can be determined for the machine or industrial vehicle based on these inputs. This idealized or optimized work function curve for any given set of inputs is defined as the pressure efficiency target or optimum pressure (OP). OP can approach MaxP but not exceed MaxP for any given set of parameters. When the pressure sensed is less than MaxP and less than OP or a range around OP, the work being done is not at maximum efficiency for the rotational speed of the tool and this condition is referred to as “freewheeling”, meaning the tool is inefficiently being operated at a higher rate of rotational speed and additional material is needed to be fed to the system. This in turn will increase pressure on the system and be detected as such. Modulation of the pressure measured to at or near OP is the function of the exemplary embodiment of the controller 500 of the instant invention.

FIG. 7 shows a flow chart for the operation of an element of the controller of an exemplary embodiment of the instant invention managing attachment pressure and advancement velocity. The attachment controller or subcontrol element of the vehicle controller 500, as shown in FIG. 5A or alternatively as an attachment controller 500 in communication with the vehicle controller 600 as shown in FIG. 5B, manages the advancement or feed velocity of the industrial vehicle or machine. The flow chart represents in part the software encoded on the controller 500 which operates the controller by the method shown with respect to the exemplary embodiment of the invention. This software can be integrated with a PID logic to eliminate the need for cycle time (570) and to minimize the error from the Optimum Pressure (OP).

The controller 500 is programmed to operate and follow the methods as disclosed. In this operation the controller has a startup cycle 505 when the attachment is engaged. The controller 500 obtains an optimum pressure “OP” as an input at step 510. This value can be stored and retrieved from a database, stored memory, operator input, or similar data source and storage in step 510. The OP can be a single variable function or a multivariate mapping of the performance curve or curves related to the attachment 100 and the working tool 150. Additionally, though not shown, a further step allowing for modification or adjustment of OP values can be provided and the adjusted data stored as OP data for retrieval. Similarly, as discussed above, a maximum pressure (MaxP) is provided at step 512 based on the pressure rating of the pressure relief valve 682 in the system. This is also obtained as an input for the controller 500 operation at step 512.

As noted above in FIGS. 1-6, at least one pressure sensor 460 provides an input for the controller 500. The at least one pressure sensor 460 also provides real time data reporting at sensing step 515 for a sensed pressure (P) to the controller 500 as previously discussed. A comparison is made first as to whether the reported pressure sensed by the sensors 460 and the communicated at input 515 is less than or equal to the MaxP provided at step 512. If the MaxP is not exceeded at the decision step 520, the method proceeds to the comparison step 530. If MaxP is exceeded, then the method immediately jumps to the step of lowering the forward velocity (V−) at 535.

This attempts to prevent overpressure of the system and triggering of the pressure relief valve. As previously discussed, if the combined pressures in the systems exceeds the crack valve pressure the result is the valve opens and reduces the pressure, potentially stalling the attachment. In some implementations, however, this can not only stall the attachment but reduce the overall power available for the vehicle. One such example of this is a flail type lawnmower attachment, whereby the mower attachment must maintain a certain rotational speed. As the vehicle, the tractor mower in this instance, starts to move faster the attachment has less power available. The maximum pressure is similarly limited by the relief valve as in other exemplary embodiments, but the available flow to the attachment will decrease as demand to keep both rotational power and velocity can result in too high a demand, meaning the tractor mower will get bogged down. This exemplary embodiment in particular would benefit from the method in FIG. 8, described herein below, measuring both optimized flow and pressure.

If the pressure is lower than MaxP in step 520, the flow chart moves to a comparison of the sensed pressure reported by the pressure sensors in step 515 to the OP value communicated in step 510 is made at step 530. If the pressure is greater than or equal to the optimized pressure (OP) at step 530, the controller maintains the status quo through a cycle time in step 570. Upon completion of the cycle time at step 570, the method compares the pressure reading to the OP, it simply resets to sample again if the P equals the OP or if it does not equal OP incrementally reduces speed V− at step 535 as a precautionary measure to prevent runaway increases in velocity. Additionally, it would be understood by one of ordinary skill in the art that strict comparison of values in the steps as outlined can be equally accomplished utilizing bounded comparisons, e.g. range values. One non-limiting example, for instance, would be if the sensed pressure (SP) were within ten percent of the MaxP or the sensed pressure were within plus or minus five percent of the optimum pressure OP, the logic test results in a positive branch result.

If the sensed pressure (SP) is less than the optimum pressure (OP) or less than the defined bounds around the optimum pressure, the signal is sent to incrementally increase velocity (+V) of the vehicle at step 525. This signal can be actuated or implemented in a number of ways. In one exemplary embodiment, the signal mimics that of the controls found in the operator compartment 40 on a control input 310, such as that of a joystick which typically includes buttons to incrementally increase velocity on such a joystick. In a further exemplary embodiment, this signal can be implemented as a signal from the attachment 100 to the industrial vehicle 10 and the SMU 605 of the industrial vehicle, as shown in FIG. 5B.

Upon completion of the incremental speed adjustment (+V) in step 525 or upon the expiry of the cycle time and the implementation of incremental speed adjustment (V−) in step 535 or if P=OP in step 580, the method restarts receiving a refreshed instantaneous sensed pressure (SP) input and comparing it to the MaxP and OP as outlined. In this fashion, once the depth of cut and other parameters are set the exemplary embodiment of the instant invention allows for the controller 500 to maintain optimum work at the tool operating environment by measurement of the pressure being demanded by the system and instantaneous changes in that pressure in real time. In this fashion the instant invention envisions a smart work output controller with at least one sensors for instantaneously detecting work done at the attachment coupled to an industrial vehicle or device and adjusting the forward velocity or feed rate without operator intervention, the controller can thereby reduce the reliance upon highly skilled operators for a consistent, smooth work output from a given device or vehicle.

FIG. 8 shows a flow chart of an exemplary embodiment of the logic used in the smart attachment control system utilizing input from a flow sensor and a pressure sensor. In this instance, a flowchart similar to that seen in FIG. 7 is provided for an alternate controller measuring and comparing pressure and flow in the system for attachments that are more reliant on consistent flow and pressure such as the aforementioned rotary mower attachment. The controller can be similarly situated to that of the controller discussed with respect to FIG. 7 above and similarly can integrate PID Logic.

The controller 500 is programmed to operate and follow the methods as disclosed in this exemplary embodiment. Additional exemplary embodiments are contemplated as discussed herein utilizing additional variables with greater degrees of complexity. These can include for instance compensatory variables and operations accommodating variable displacement motors where flow and pressure can be adjusted to suit specifically desired characteristics, a non-limiting example being to adjust torque for instance. Similarly, as noted above, extensive use of PID controllers and controller logic can be incorporated in further exemplary embodiments. This can be facilitated by selection of specifically suited components and adjusting the programming to suit, but conceptually, these embodiments are contemplated in the instant invention.

The controller 500 is programmed to operate and follow the methods as disclosed. In this operation the controller has a startup cycle 505 when the attachment is engaged. The controller 500 obtains an optimum flow “OQ” as an input at step 590 and optimum pressure “OP” as an input at step 510. These values can be stored and retrieved from a database, stored memory, operator input, or similar data source and storage in step 510 and 590. The OQ and the OP can be a single variable function or a multivariate mapping of the performance curve or curves related to the attachment 100 and the working tool 150. Additionally, though not shown, a further step allowing for modification or adjustment of both optimized values can be provided and the adjusted data stored as adjusted optimized data for retrieval. Similarly, as discussed above, a maximum pressure (MaxP) is provided at step 512 based on the pressure rating of the pressure relief valve 682 in the system. This is also obtained as an input for the controller 500 operation at step 512.

As noted above in relation to the alternate exemplary embodiment described for a flail mower, an at least one sensor 460 provides an input for the controller 500 for both measured pressure (P) and flow (Q) for the attachment. The at least one sensor 460 also provides real time data reporting at sensing step 515 to the controller 500 as previously discussed. A comparison is made first as to whether the reported pressure sensed by the sensors 460 and the communicated at input 515 is less than or equal to the MaxP provided at step 512. If the MaxP is not exceeded at the decision step 520, the method proceeds to the comparison steps 530-590. If MaxP is exceeded, then the method immediately jumps to the step of lowering the forward velocity (V−) at 535.

This attempts to prevent overpressure of the system and triggering of the pressure relief valve, also known as stalling as described herein above. As previously discussed, if the combined pressures in the systems exceed the crack valve pressure the result is the valve opens and reduces the pressure, potentially stalling the attachment. Again, in these implementations this can not only stall the attachment but reduce the overall power available for the vehicle. The alternate exemplary embodiment discussed above is a flail type lawnmower attachment, whereby the mower attachment must maintain a certain rotational speed. As the vehicle, typically the tractor mower in this instance, starts to move faster the attachment has less power available. The maximum pressure is similarly limited to the pressure only embodiment by the relief valve and maximum pressure limitations as in other exemplary embodiments, but the available flow to the attachment can decrease as demand to keep both rotational power and forward velocity results in too high a demand, meaning the tractor mower will get bogged down. This exemplary embodiment in particular is measuring both optimized flow and pressure as noted.

If the pressure is lower than MaxP in step 520, the flow chart moves to a comparison of the flow reported by the at least one sensor in step 585 to the OQ value communicated in step 590, this comparison is made at step 580. If the flow is greater than or equal to the optimized flow, the forward velocity of the attachment 100 and its carrier are increased at step 525 to decrease flow. This decreases the angular velocity of the flail component of the rotating components. The controller then returns as shown. If the flow measurement is less than the OQ limit, the system continues on to compare the pressure at step 530.

At step 530, the flow chart moves to a comparison of the pressure reported by the pressure sensors in step 515 to the OP value communicated in step 510, this is identical to the previous comparisons. If the sensed pressure (P) is lower than the optimized pressure, the system continues to increase the forward velocity of the carrier having the attachment 100 is increased via same step 525 and cycles back as shown. If the pressure is greater than the optimized pressure (OP) at step 530, the controller maintains the status quo through a cycle time in step 570. Upon completion of the cycle time at step 570, the method compares the pressure reading to the OP, it simply resets to sample again if the P equals the OP as shown or if it does not equal OP incrementally reduces speed V− at step 535 as a precautionary measure to prevent runaway increases in power.

If the pressure is greater than or equal to the optimized pressure (OP) at step 530, the controller maintains the status quo through a cycle time in step 570. Upon completion of the cycle time at step 570, the method compares the pressure reading to the OP at 590, it simply resets to sample again if the P equals the OP or if it does not equal OP incrementally reduces speed V− at step 535 as a precautionary measure to prevent runaway increases in velocity. Additionally, it would be understood by one of ordinary skill in the art that strict comparison of values in the steps as outlined can be equally accomplished utilizing bounded comparisons as previously noted. One non−limiting example, for instance, would be if the sensed pressure (SP) were within ten percent of the MaxP or the sensed pressure were within plus or minus five percent of the optimum pressure OP, the logic test results in a positive branch result.

If the sensed pressure (SP) is less than the optimum pressure (OP) or less than the defined bounds around the optimum pressure, the signal is sent to incrementally increase velocity (+V) of the vehicle at step 525. This signal can be actuated or implemented in a number of ways. In one exemplary embodiment, the signal mimics that of the controls found in the operator compartment 40 on a control input 310, such as that of a joystick which typically includes buttons to incrementally increase velocity on such a joystick. In a further exemplary embodiment, this signal can be implemented as a signal from the attachment 100 to the industrial vehicle 10 and the SMU 605 of the industrial vehicle, as shown in FIG. 5B.

Upon completion of the incremental speed adjustment +V in step 525 or upon the expiry of the cycle time and the implementation of V− in step 535, the method restarts receiving a refreshed instantaneous sensed pressure (SP) input and comparing it to the MaxP and OP as outlined. In this fashion, once the depth of cut and other parameters are set the instant invention allows for the controller 500 to maintain optimum work at the tool operating environment by measurement of the pressure being demanded by the system and instantaneous changes in that pressure in real time. In this fashion the instant invention envisions a smart work output controller with at least one sensors for instantaneously detecting work done at the attachment coupled to an industrial vehicle or device and adjusting the forward velocity or feed rate without operator intervention, the controller can thereby reduce the reliance upon highly skilled operators for a consistent, smooth work output from a given device or vehicle. The above method can be modified in an alternate embodiment to process pressure and flow measurements in parallel and the resulting OP/OQ map the output to a multivariate surface instead of simple curve.

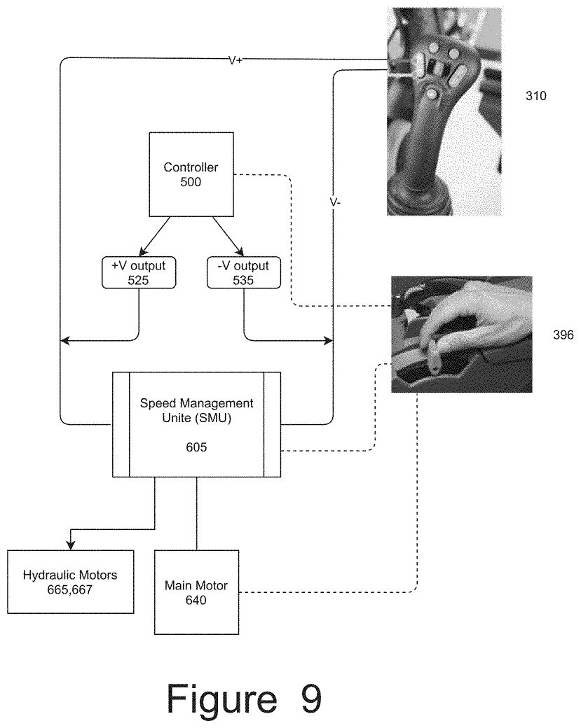

FIG. 9 shows a plan view further exemplary embodiment of the controller of the instant invention. The yet further exemplary embodiment shown in FIG. 9 is similar to that shown in FIG. 5A, whereby the controller 500 directly communicates the incremental increase V+ to the SMU 605. Operator input 310 is shown as a joystick with a thumb button to increase or decrease velocity, which is replicated in the instant invention by the controller. And an additional input 396 is shown directly controlling power or throttle setting for the main motor 660. However, in this instance, the SMU 605 can send control signals to the primary motor 660 or to the hydraulic pumps 83, 87 directly driving the wheels or tracks 25. Each of these examples are non-limiting examples to illustrate the nature of control of the vehicle speed utilized by the instant invention. Additional means for implementing incremental speed adjustment in concert with the measurement of parameters, such as but not limited to pressure, flow and pressure and flow sensors, with such incremental speed adjustment are known and that become known are within the scope of the instant invention.

In still further non-limiting exemplary embodiments of the instant invention, additional sensors or alternative sensors detecting the rotational speed of the attachment motor can be utilized to determine work done by the tool. Rotational speeds of such motors are directly related to flow rates and motor displacement and this information could also be used as input into the controller. In such an alternate embodiment, optical sensors could be utilized if dust were minimized, rotational speed can also be measured magnetically or with a micro switch or similar sensor detecting rotational movement. Similarly, in further exemplary embodiments, direct measurement of work can be carried out in electric motors by measuring current flow or electrical frequency to the electric motor, thus in attachments utilizing electric motors, this could also be used as an indicator of the load being applied to the processing tool. This direct measurement of work can then be incorporated into the instant invention and the controller of the exemplary embodiment directly.

The embodiments and examples discussed herein are non-limiting examples. The invention is described in detail with respect to preferred embodiments, and it will now be apparent from the foregoing to those skilled in the art that changes and modifications can be made without departing from the invention in its broader aspects, and the invention, therefore, as defined in the claims is intended to cover all such changes and modifications as fall within the true spirit of the invention.

What is claimed is:

1. A skid steer loader having a planar attachment coupled thereto, comprising:
a skid steer loader frame;
an attachment frame;
a skid steer loader drive engine powering the skid steer loader and providing a forward velocity for the skid steer loader;
an at least one hydraulic system having an at least one hydraulic motor powered by the drive engine and powering the attachment;
an at least one hydraulic manifold coupled to the at least one hydraulic system with an at least one attachment hydraulic line powering an at least one attachment hydraulic motor powering the working element of the attachment;
an at least one sensor sensing an at least one input in the at least one hydraulic line powering the at least one attachment hydraulic motor; and
a controller, wherein the controller is adapted to receive the sensed at least one input from the at least one sensor and correlate the at least one input to the work being done at the attachment and to maintain the at least one input in an optimum range and thereby optimize the work output of the attachment upon a work surface.

2. The loader of claim 1, wherein controller adjusts the work being done at the attachment by adjusting the forward velocity of the skid steer loader and thereby the feed rate of material to the attachment.

3. The loader of claim 1, wherein the at least one sensor sensing an input in the at least one hydraulic line senses at least one of a pressure, a flow, a flow and a pressure.

4. The loader of claim 1, where the at least one sensor sensing the at least one input in the at least one hydraulic line senses at least one pressure of the working element of the attachment.

5. The skid steer of claim 4, further comprising an at least one further measured variable sensed by the at least one sensor or from a further at least one sensor, the at least one further measured variable being at least one of a hydraulic fluid flow rate, a hydraulic fluid temperature, a hydraulic fluid flow, a variable displacement setting in the hydraulic system, torque at the working element, orifice sizes, the pressure difference between the inlet and outlet of a hydraulic manifold, external or ambient temperatures, rotation speed of cutting head and gauge pressure.

6. The skid steer of claim 5, wherein the controller adjusts the forward velocity based on the at least one input in combination with the at least one further sensed variable to optimize work at the attachment.

7. The skid steer of claim 6, wherein the controller adjusts the forward velocity based on the at least one input in combination with the at least one further sensed variable and calculates the target values for the optimization of the work output of the attachment as sensed by and adjusting to maintain the sensed at least one input and further sensed variables in computed optimized ranges.

8. The skid steer of claim 7, further comprising an at least one PID controller to control the at least one sensed input within the mapped optimized range.

9. The skid steer of claim 8, further comprising a further PID controller to control the at least one further measured variable.

10. The skid steer of claim 1, further comprising at least one user programmable input.

11. The skid steer of claim 10, wherein the at least one user programmable input is at least one of a model designator, a displacement, material variables, a tool life estimate, at least one input related to the working surface material or surface composition, material consistency or specific descriptors related to the processing tools or attachment, outdoor temperature, hours in service, an at least one variable representing tool wear, processed area, density, toughness, and strength of the surface material.

12. The skid steer loader of claim 1, wherein the operating attachment is a planer, mower, tiller, soil conditioner, trencher, snow blower, or wheel saw.

13. The skid steer loader of claim 1, wherein the controller accesses a stored, mapped performance curve or surface based on a sensed variable chosen from at least one of pressure, flow, or pressure and flow to set an optimal efficiency target for the work being done at the attachment and determining with the at least one sensed variable where the current operation is relative to that curve and adjusting to move toward the optimized value of the sensed variable.

14. The skid steer of claim 13, wherein the controller has an at least one machine learning element, wherein the machine learning element adjusts the stored, mapped performance curve or surface.

15. The skid steer of claim 14, wherein the at least one machine learning element interrogates, stores, and adjusts the performance curve or surfaced based on historical sampling of the at least one sensed variable.

16. An add-on or retrofit kit for an existing attachment which couples to a vehicle mounting the attachment with speed management or speed creep controls, comprising:
an attachment frame;
a hydraulic manifold coupled to a hydraulic system of the vehicle and having an at least one hydraulic drive motor;
an at least one sensor sensing an at least one variable of the at least one hydraulic drive motor or hydraulic manifold, the sensed variable correlating to the work output of the attachment; and
an attachment controller, wherein the at least one variable is sensed and reported to the controller and compared to an optimized working range for the variable, the attachment controller is adapted to send a signal to control the speed of the vehicle utilizing the speed management or speed creep control signals to control the speed of the vehicle and thereby the feed rate of material to the attachment and thereby control the work done by the attachment by maintaining the at least one variable in the optimized working range.

17. The kit of claim 16, wherein an at least one user input is set by a user of the vehicle.

18. The kit of claim 16, wherein the at least one user input further comprises at least one of an input that sets initial vehicle speed, sets or accesses or calculates maximum work values for the attachment, and control elements to automatically adjust the sensed variables to achieve and maintain this maximum work value as a function of the sensed variables.

19. The kit of claim 16, wherein the at least one sensor sensing a variable senses at least one of a pressure, a flow, a flow and a pressure in the hydraulic system, the at least one hydraulic manifold or the at least one attachment motor as the at least one sensed input.

20. The kit of claim 19, wherein the controller is further adapted to adjust the forward velocity of the vehicle and thereby the feed rate of material to the attachment and in turn changes the sensed at least one pressure flow, and flow and a pressure.

21. The kit of claim 16, wherein the vehicle is one of a lawn mower, tractor, tiller, excavator, dozer, self-propelled saw, tracked loader, wheeled loader, dozer, vehicles with bundler, landscape rake, mulcher, stone crusher, sifting vehicle, planer, beach cleaner, soil conditioner, snow blower, stump grinder, flail mower, rotary mower, wheel saw, asphalt saw cutter, trencher, and planer.

22. A controller controlling an industrial device or vehicle based directly on a calculated estimate of work being done at the working element of an attachment, comprising:
a programmable logic controller;
a data storage device coupled to the controller;
an at least one sensor sensing at least one variable that is used to calculate the estimate of work being done at the processing motor;
an at least one output controlling an at least one parameter that increases or decreases proportionately with the at least on variable and thereby increases or decreases the calculated estimate of work done at the processing motor, wherein the controller is adapted to calculate the estimated work done by receiving the at least one variable sensed by the at least one sensor, calculating an estimate of work, comparing this calculated value against an optimal calculated value and adjusting the at least one output through the increase or decrease of the at least one output and thereby the at least one parameter to adjust the estimate of work.

23. The automated controller of claim 22, further comprising an at least one electric system wherein the processing element is electrically powered and coupled to the at least electric system.

24. The automated controller of claim 22, wherein the at least one variable is at least one of pressure.

25. The automated controller of claim 24, wherein the optimal variable is adjusted by further inputs.

26. The automated controller of claim 25, further inputs include at least one of time in service, wear factor, material composition, temperature, a hydraulic fluid flow rate, a hydraulic fluid temperature, a hydraulic fluid flow, a variable displacement setting in the hydraulic system, torque at the working element, orifice sizes, the pressure difference between the inlet and outlet of a hydraulic manifold, external or ambient temperatures, rotation speed of cutting head.

27. The automated controller of claim 22, wherein the at least one output is a feed rate of material to the attachment.

28. The automated controller of claim 28, wherein the feed rate of material to the attachment is adjusted by the increase or decrease in the speed of a vehicle to which the attachment is coupled.

29. A method of controlling an attachment having an attachment work optimizing controller and coupled to a vehicle, comprising the method steps of:
engaging an attachment;
conducting a startup sequence;
setting user inputs using a user interface;
engaging the attachment to work on a work surface;
sensing with an at least one sensor an at least one variable representing an estimate of the work done through a working element of the attachment working upon the work surface;
calculating an estimated work value for work done at the attachment from the at least one sensor;
comparing the estimated work value to an optimized work target for the work done at the attachment;
controlling an output, wherein the output is adjusted by the controller and effects the at least one variable so that the estimated work value remains within a defined bounded value around the target optimized work value.

30. The method of claim 30, wherein the attachment has a motor and is driven by an at least one hydraulic system.

31. The method of claim 30, wherein the sensed at least one variable is an at least one of a pressure, a flow, and a pressure and a flow.

32. The method of claim 30, wherein the sensed at least one variable is an at least one pressure.

33. The method of claim 30, wherein the output is the velocity of the vehicle which directly affects the feed rate of the work surface.

34. The method of claim 30, further comprising the step of calculating from the user inputs the optimized work target.

35. The method of claim 30, wherein the method step of setting user inputs further comprises accessing an at least one database of variables.

36. The method of claim 37, wherein the method step of setting user inputs further comprises accessing the database for limits for the attachment or a material being worked upon or both.
